(19) United States
(12) Patent Application Publication
(10) Pub. No.: US 2019/0332944 A1
(43) Pub. Date: Oct. 31, 2019

(54) Training Method, Apparatus, and Chip for Neural Network Model

(71) Applicant: Huawei Technologies Co., Ltd., Shenzhen (CN)

(72) Inventors: Xiaolong Bai, Hangzhou (CN); Changzheng Zhang, Shenzhen (CN); Mingzhen Xia, Hangzhou (CN)

(21) Appl. No.: 16/425,012

(22) Filed: May 29, 2019

Related U.S. Application Data
(63) Continuation of application No. PCT/CN2017/092092, filed on Jul. 6, 2017.

(30) Foreign Application Priority Data
Nov. 29, 2016 (CN) 201611076461.2

(51) Int. Cl. G06N 3/08; G06N 3/04

(52) U.S. Cl. CPC G06N 3/084; G06N 3/04

(57) ABSTRACT

A training method, apparatus, and chip for a neural network model includes determining a model training mode of each layer based on an estimated data volume in a model parameter set and an estimated data volume of output data of the layer, obtaining second output data that is obtained by m worker modules by training a (j−1)^{th} layer, and directly obtaining by a worker module a global gradient of a model parameter by training the model parameter based on the second output data when a model parallel training mode is used for a j^{th} layer.

### CROSS-REFERENCE TO RELATED APPLICATIONS

This application is a continuation application of International Application No. PCT/CN2017/092092, filed on Jul. 6, 2017, which claims priority to Chinese Patent Application No. 201611076461.2, filed on Nov. 29, 2016. The disclosures of the aforementioned applications are hereby incorporated by reference in their entireties.

### TECHNICAL FIELD

Embodiments of this application relate to the field of neural network model training, and in particular, to a training method, apparatus, and chip for a neural network model.

### BACKGROUND

Since deep learning achieves great success in large-scale image classification data sets, development of deep learning has been vigorously promoted by the academic circles, government, and industry, and new achievements are continuously made. As a major form of model in deep learning, a feedforward neural network model currently starts to be widely used in tasks such as facial recognition, image classification, target detection, video analysis, and is rapidly used by major machine vision manufacturers for products such as intelligent image and video processing. Currently, the feedforward neural network model is becoming deeper and having a more complex structure. For example, in many tasks of intelligent image and video processing, data is increasing all the time. In this case, a training system needs to have a sufficiently high training speed and to be rapidly updated to meet a latest mission requirement.

Currently, training acceleration of the feedforward neural network model mainly relies on a large-scale distributed parallel computing system. Currently, a parameter server computing architecture is relatively commonly used, and an effective stochastic gradient descent algorithm is cooperatively used for training. FIG. 1 is an example of a schematic diagram of a distributed system architecture in the prior art. As shown in FIG. 1, the distributed system architecture includes a server module set 101 and a worker module set 102. The server module set may include a plurality of server modules (which may be referred to as a server). The worker module set may include a plurality of worker modules (which may be referred to as each worker). The server module is similar to a master server (which may be referred to as a master) node. The worker module may represent a calculation performer. The distributed system architecture includes a plurality of distributed nodes. Each node may include one or more worker modules, or may further include one or more server modules.

Using FIG. 1 as an example, a signaling interaction process between a server module and a worker module in a distributed system architecture is described in detail. FIG. 1 includes N worker modules and M server modules. N and M are integers greater than or equal to 1. A neural network model includes L layers. L is an integer greater than or equal to 1. Each layer includes a plurality of model parameters. Each worker module performs a plurality of iterative calculations. In each iterative calculation, the worker module performs a forward algorithm and a backward algorithm on the L layers, to obtain a local gradient of a model parameter in the neural network model. Subsequently, each worker module uploads the local gradients of all the model parameters to the server module. The server module calculates a global gradient of each model parameter, and the global gradient is pulled from the server module to each worker module. Each worker module updates each model parameter based on the obtained global gradient of each model parameter, and performs a next iteration based on the updated model parameters.

In the foregoing solution, the L layers of the neural network model include a large quantity of model parameters. Therefore, application of the solution causes each worker module to push a large quantity of local gradients of the model parameters to the server module, and pull a large quantity of global gradients of the model parameters from the server module. Consequently, there is a relatively large information communication volume between the server module and each worker module.

### SUMMARY

Embodiments of this application provide a training method, apparatus, and chip for a neural network model, to reduce a communication volume between a server module and each worker module in a neural network model training process, and increase a speed of training a neural network model.

According to a first aspect, an embodiment of this application provides a training method for a neural network model. The method is applied to a training system that includes M worker modules. The neural network model includes L layers. M and L are integers greater than or equal to 1. For each of the L layers of the neural network model, at least one of the M worker modules is used to train the layer. The method includes, for each of the L layers of the neural network model, determining, by each of the at least one worker module, a model training mode of the layer based on an estimated data volume in a model parameter set and an estimated data volume of output data of the layer, where the model training mode includes a data parallel training mode and a model parallel training mode, and the model parameter set includes all model parameters of the layer; and performing, by each of the at least one worker module, the following operations to train the layer. In an operation, when a forward algorithm of calculation from a first layer to an L^{th} layer is performed, and j is an integer greater than 1 and less than or equal to L, when the layer is the first layer in the neural network model, if the data parallel training mode is used for the first layer, using, by the worker module, first input data as input data of the first layer, and performing data parallel training on a model parameter of the first layer, where the first input data is initial training data corresponding to the worker module; or if the model parallel training mode is used for the first layer, using, by the worker module, second input data as input data of the first layer of the worker module, and performing model parallel training on a model parameter of the first layer, where the second input data is initial training data corresponding to the at least one worker module; or when the layer is a j^{th} layer in the neural network model, if the data parallel training mode is used for the j^{th} layer, using, by the worker module, first output data as input data of the j^{th} layer, and performing data parallel training on a model parameter of the j^{th} layer, where the first output data is output data obtained by the worker module by training a (j−1)^{th} layer; or if the model parallel training mode is used for the j^{th} layer, using, by the worker module, second output data as input data of the j^{th} layer, and performing model parallel training on a model parameter of the j^{th} layer, where the second output data is output data obtained by m worker modules by training a (j−1)^{th} layer, the m worker modules are one or more worker modules used for training the (j−1)^{th} layer, m is an integer greater than or equal to 1 and less than or equal to M, and a value of m of at least one of the L layers is greater than 1.

In this embodiment of this application, the model training mode of each layer is determined based on the estimated data volume in the model parameter set and the estimated data volume of the output data of the layer. In this way, if the model parallel training mode is used for the j^{th} layer, the worker module uses the second output data as the input data of the j^{th} layer, and performs the model parallel training on the model parameter of the j^{th} layer. The second output data is the output data obtained by the m worker modules by training the (j−1)^{th} layer. In an embodiment, for the j^{th} layer corresponding to the model parallel training mode, the worker module receives the output data of the m worker modules. The data may be referred to as full data. The worker module may directly obtain a global gradient of a model parameter by training the model parameter based on the full data. Therefore, compared with a prior art solution in which a worker module pushes a local gradient of a model parameter to a server module and pulls a global gradient of the model parameter from the server module to obtain the global gradient of the model parameter, this embodiment of this application reduces a communication volume between the worker module and the server module.

Further, during training of the neural network module, communication between the worker module and the server module takes a relatively long time. Therefore, as the communication volume between the worker module and the server module in this embodiment of this application decreases, a speed of training the neural network model in this embodiment of this application increases accordingly.

Optionally, the determining a model training mode of the layer based on an estimated data volume in a model parameter set and an estimated data volume of output data of the layer includes, when the estimated data volume in the model parameter set is not greater than the estimated data volume of the output data of the layer, determining that the model training mode of the layer is the data parallel training mode; or when the estimated data volume in the model parameter set is greater than the estimated data volume of the output data of the layer, determining that the model training mode of the layer is the model parallel training mode.

In an implementation, the data parallel training mode is used for a layer whose estimated data volume of output data is relatively large. In the data parallel training mode, the worker module uses output data of a layer as input data of a next layer in the neural network model. The worker module pushes a local gradient of a model parameter to the server module, and pulls a global gradient of the model parameter from the server module. Because the estimated data volume in the model parameter set of the layer corresponding to the data parallel training mode is relatively small, the communication volume transmitted between the worker module and the server module is relatively small. Correspondingly, the model parallel training mode is used for a layer whose estimated data volume in a model parameter set is relatively large. In the model parallel training mode, the worker module may directly obtain a global gradient of a model parameter by training the model parameter based on the full data. Therefore, compared with the prior art solution in which a worker module pushes a local gradient of a model parameter to a server module, and pulls a global gradient of the model parameter from the server module to obtain the global gradient of the model parameter, this embodiment of this application greatly reduces the communication volume between the worker module and the server module.

Optionally, if the model parallel training mode is used for the j^{th} layer, using, by the worker module, second output data as input data of the j^{th} layer, and performing model parallel training on a model parameter of the j^{th} layer includes determining, by the worker module based on a model parameter set of the j^{th} layer, a model parameter subset that is of the j^{th} layer and that is to be trained by the worker module; and using, by the worker module, the second output data as the input data of the j^{th} layer, and performing the model parallel training on the model parameter subset of the j^{th} layer. An intersection set between model parameter subsets of the j^{th} layer that are trained by any two of the at least one worker module is empty. A union set of model parameter subsets of the j^{th} layer that are trained by all of the at least one worker module is equal to a universal set of model parameters of the j^{th} layer. In this way, a model parameter subset is allocated to each of the m worker modules that trains the layer. Therefore, all of the m worker modules are used to train the model parameter subsets, thereby increasing a speed of training the model parameter.

Optionally, if the model parallel training mode is used for the j^{th} layer, before the performing, by each of the at least one worker module, the following operations to train the layer, the method further includes the following steps. In step A, setting a value of i to an integer greater than or equal to 1 and less than or equal to M, estimating a first total duration spent by i worker modules on training, and performing step B, where the first total duration is an estimated total duration spent by all of the i worker modules on receiving the second input data and training the model parameter of the j^{th} layer based on the second input data; step B includes updating the value of i, where the updated value of i is another integer greater than or equal to 1 and less than or equal to M, and performing step C. step C includes estimating a second total duration spent by updated i worker modules on training, where the second total duration is an estimated total duration spent by all of the updated i worker modules on receiving the second input data and training the model parameter of the j^{th} layer based on the second input data, where each value of i corresponds to one total duration; and if a sum of a quantity of first total durations and a quantity of second total durations is less than a quantity threshold, performing the step B; or if a sum of a quantity of first total durations and a quantity of second total durations is equal to a quantity threshold, performing step D. Step D includes determining a total duration with a smaller value in the first total duration and the second total duration, and using a value that is of i and that corresponds to the total duration with a smaller value as a determined value of a quantity of the at least one worker module used for training the j^{th} layer.

In this solution, a trade-off is found between training of the layer by the worker module and transmission of the input data in this embodiment of this application, to reduce as much as possible a sum of a training duration that is of the layer and that corresponds to the determined quantity of worker modules that train the model parameter of the j^{th} layer and a transmission duration of the input data.

Optionally, if the model parallel training mode is used for the j^{th} layer, the second output data is divided into a first input data subblock and a second input data subblock; and using, by the worker module, second output data as input data of the j^{th} layer, and performing model parallel training on a model parameter of the j^{th} layer includes receiving, by the worker module, the first input data subblock; performing in parallel, by the worker module, the following steps In a step, performing the model parallel training on the model parameter of the j^{th} layer based on the first input data subblock, to obtain first output subdata of the j^{th} layer, and receiving the second input data subblock; and performing in parallel, by the worker module, the following steps. The steps include performing the model parallel training on the model parameter of the j^{th} layer based on the second input data subblock, to obtain second output subdata of the j^{th} layer, and transmitting the first output subdata of the j^{th} layer to a (j+1)^{th} layer. A communication process of a communications module and a training process of a training module are performed in parallel. In other words, the training process and the communication process are performed in parallel, thereby increasing a speed of training the neural network model.

Optionally, a total duration t spent by the m worker modules on separately receiving the second input data and training the model parameter of the j^{th} layer based on the second input data is estimated in the following manner. t=max{t1, t3}+max{t2, t3}, where t1 is a duration spent by the m worker modules on receiving the second input data subblock; t2 is a duration spent by the m worker modules on transmitting the first output subdata of the j^{th} layer to the (j+1)^{th} layer; and t3 is a duration spent by the m worker modules on performing the model parallel training on the model parameter of the j^{th} layer based on the first input data subblock to obtain the first output subdata of the j^{th} layer; or t3 is a duration spent by the m worker modules on performing the model parallel training on the model parameter of the j^{th} layer based on the second input data subblock to obtain the second output subdata of the j^{th} layer. In this way, the total duration t spent by the m worker modules on separately receiving the second input data and training the model parameter of the j^{th} layer based on the second input data can be more accurately determined.

Optionally, after determining, by each of the at least one worker module, a model training mode of the layer based on an estimated data volume in a model parameter set and an estimated data volume of output data of the layer, the method further includes, if a backward algorithm of calculation from the L^{th} layer to the first layer is performed, and j is an integer greater than or equal to 1 and less than L, when the layer is the L^{th} layer in the neural network model, if the data parallel training mode is used for the L^{th} layer, using, by the worker module, third input data as input data of the L^{th} layer, and performing data parallel training on a model parameter of the L^{th} layer, where the third input data is output data that is of the L^{th} layer in the forward algorithm and that corresponds to the worker module; or if the model parallel training mode is used for the L^{th} layer, using, by the worker module, fourth input data as input data of the L^{th} layer of the worker module, and performing model parallel training on a model parameter of the L^{th} layer, where the fourth input data is output data obtained by the at least one worker module by training the model parameter of the L^{th} layer in the forward algorithm; or when the layer is a j^{th} layer in the neural network model, if the data parallel training mode is used for the j^{th} layer, using, by the worker module, third output data as input data of the j^{th} layer, and performing data parallel training on a model parameter of the j^{th} layer, where the third output data is output data obtained by the worker module by training a (j+1)^{th} layer; or if the model parallel training mode is used for the j^{th} layer, using, by the worker module, fourth output data as input data of the j^{th} layer, and performing model parallel training on a model parameter of the j^{th} layer, where the fourth output data is output data obtained by m worker modules by training a (j+1)^{th} layer, the m worker modules are one or more worker modules used for training the (j+1)^{th} layer, m is an integer greater than or equal to 1 and less than or equal to M, and a value of m of at least one of the L layers is greater than 1.

For the j^{th} layer corresponding to the model parallel training mode, the worker module receives the output data of the m worker modules. The data may be referred to as full data. The worker module may directly obtain a global gradient of a model parameter by training the model parameter based on the full data. Therefore, compared with the prior art solution in which a worker module pushes a local gradient of a model parameter to a server module and pulls a global gradient of the model parameter from the server module to obtain the global gradient of the model parameter, this embodiment of this application reduces the communication volume between the worker module and the server module.

Optionally, if a backward algorithm of calculation from the L^{th} layer to the first layer is performed, j is an integer greater than or equal to 1 and less than L, and the model parallel training mode is used for the j^{th} layer, using, by the worker module, fourth output data as input data of the j^{th} layer, and performing model parallel training on a model parameter of the j^{th} layer includes determining, by the worker module based on a model parameter set of the j^{th} layer, a model parameter subset that is of the j^{th} layer and that is to be trained by the worker module; and using, by the worker module, the fourth output data as the input data of the j^{th} layer, and performing the model parallel training on the model parameter subset of the j^{th} layer. An intersection set between model parameter subsets of the j^{th} layer that are trained by any two of the at least one worker module is empty. A union set of model parameter subsets of the j^{th} layer that are trained by all of the at least one worker module is equal to a universal set of model parameters of the j^{th} layer. In this way, a model parameter subset is allocated to each of the m worker modules that trains the layer. Therefore, all of the m worker modules are used to train the model parameter subsets, thereby increasing a speed of training the model parameter.

Optionally, if a backward algorithm of calculation from the L^{th} layer to the first layer is performed, j is an integer greater than or equal to 1 and less than L, and the model parallel training mode is used for the j^{th} layer and the fourth output data is divided into a third input data subblock and a fourth input data subblock. The using, by the worker module, fourth output data as input data of the j^{th} layer, and performing model parallel training on a model parameter of the j^{th} layer includes receiving, by the worker module, the third input data subblock; performing in parallel, by the worker module, the following steps. The steps include performing the model parallel training on the model parameter of the j^{th} layer based on the third input data subblock, to obtain third output subdata of the j^{th} layer, and receiving the fourth input data subblock; and performing in parallel, by the worker module, the following steps. The steps include performing the model parallel training on the model parameter of the j^{th} layer based on the fourth input data subblock, to obtain the fourth output subdata of the j^{th} layer, and transmitting the third output subdata of the j^{th} layer to a (j−1)^{th} layer. A communication process of a communications module and a training process of a training module are performed in parallel. In other words, the training process and the communication process are performed in parallel, thereby increasing a speed of training the neural network model.

According to a second aspect, an embodiment of this application provides a training apparatus for a neural network model. The training apparatus is configured to perform any method performed by the worker module according to the first aspect, and includes corresponding functional modules, separately configured to implement the steps in the foregoing method.

According to a third aspect, an embodiment of this application provides a training apparatus for a neural network model. The training apparatus includes a processor, a memory, and a transceiver. The processor includes at least one processor core. The training apparatus is applicable to a training system that includes M processor cores. The neural network model includes L layers. M and L are integers greater than or equal to 1. For each of the L layers of the neural network model, the at least one processor core is used to train the layer. The memory is configured to store an instruction. The processor is configured to execute the instruction stored in the memory, and control the transceiver to transmit data to another processor core in the M processor cores. When the processor executes the instruction stored in the memory, each of the at least one processor core is configured to perform any method performed by the worker module according to the first aspect.

According to a fourth aspect, an embodiment of this application provides a training chip for a neural network model. The chip is applicable to a training system that includes M chips. The neural network model includes L layers. M and L are integers greater than or equal to 1. For each of the L layers of the neural network model, at least one of the M chips is used to train the layer. Each of the at least one chip is configured to perform any method performed by the worker module according to the first aspect.

According to a fifth aspect, a computer program product is provided. The computer program product includes a computer program (which may also be referred to as code or an instruction). When run or executed, the computer program causes the computer to perform the method according to any possible implementation of the first aspect.

According to a sixth aspect, a computer readable medium is provided. The computer readable medium stores a computer program (which may also be referred to as code or an instruction). When running on a computer, the computer program causes the computer to perform the method according to any possible implementation of the first aspect.

In the embodiments of this application, the model training mode of each layer is determined based on the estimated data volume in the model parameter set and the estimated data volume of the output data of the layer. In this way, if the model parallel training mode is used for the j^{th} layer, the worker module uses the second output data as the input data of the j^{th} layer, and performs the model parallel training on the model parameter of the j^{th} layer. The second output data is the output data obtained by the m worker modules by training the (j−1)^{th} layer. To be specific, for the j^{th} layer corresponding to the model parallel training mode, the worker module receives the output data of the m worker modules. The data may be referred to as full data. The worker module may directly obtain the global gradient of the model parameter by training the model parameter based on the full data. Compared with the prior art solution in which a worker module pushes a local gradient of a model parameter to a server module and pulls a global gradient of the model parameter from the server module to obtain the global gradient of the model parameter, the embodiments of this application reduce the communication volume between the worker module and the server module.

### BRIEF DESCRIPTION OF DRAWINGS

FIG. 1 is a schematic diagram of a distributed system architecture;

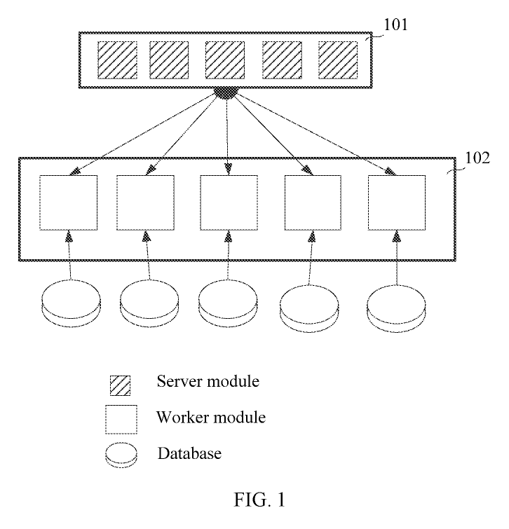

FIG. 2 is a schematic architectural diagram of an application scenario applicable to an embodiment of this application;

FIG. 3 is a schematic diagram of an applicable system architecture according to an embodiment of this application;

FIG. 4A and FIG. 4B are a schematic flowchart of a training method for a neural network model according to an embodiment of this application;

FIG. 5 is a schematic flowchart of a method for determining a value of a quantity of at least one worker module used for training a j^{th} layer according to an embodiment of this application;

FIG. 6 is a schematic flowchart of a training method for a neural network model according to an embodiment of this application;

FIG. 7 is a schematic flowchart of a training method for a neural network model according to an embodiment of this application;

FIG. 8 is a schematic diagram of a method for a forward algorithm for a third layer and a fourth layer in FIG. 7;

FIG. 9 is a schematic diagram of a work process of a worker module 502 in FIG. 6 to FIG. 8;

FIG. 10 is a schematic structural diagram of a training apparatus for a neural network model according to an embodiment of this application; and

FIG. 11 is a schematic structural diagram of another training apparatus for a neural network model according to an embodiment of this application.

### DESCRIPTION OF EMBODIMENTS

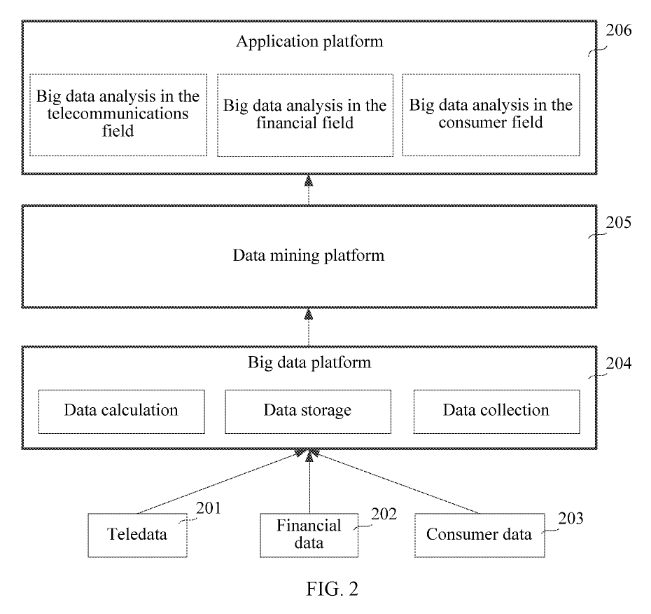

FIG. 2 is an example of a schematic architectural diagram of an application scenario applicable to an embodiment of this application. As shown in FIG. 2, in an implementation, there may be various raw data, for example, teledata 201, financial data 202, and consumer data 203 in FIG. 2. A big data platform 204 performs data collection, data storage, data calculation, or the like on the raw data. Then data processed by the big data platform 204 is obtained. A data mining platform 205 obtains, from the big data platform, the data processed by the big data platform 204, and performs data mining, for example, performs data mining using at least one of deep learning models such as regression analysis such as Logistic Regression (LR), a large-scale traditional machine learning model such as Latent Dirichlet Allocation (LDA), a convolutional neural network (CNN), a recurrent neural network (RNN), and a Sparse AutoEncoder (SAE). An application platform 206 includes applications applicable to big data analysis in various fields, and can perform, based on a data mining result determined by the data mining platform 205, big data analysis in the telecommunications field, big data analysis in the financial field, big data analysis in the consumer field, big data analysis in another field, and the like.

This embodiment of this application may be used to train a distributed parallel computer cluster of massive data. Suitable algorithms include various deep learning algorithms such as a CNN (for image, speech, or video processing), a RNN (for natural language processing), and a deep neural network (for speech processing), and a large-scale machine learning algorithm.

The solution provided by this embodiment of this application is applied to the data mining platform 205. The data mining platform 205 can perform mining analysis on underlying raw data through deep learning intelligent analysis, and improve, through an accelerated training process of a distributed architecture, performance and scalability of the data mining platform trained based on the deep learning, thereby supporting decision-making and operation of an upper-layer application platform, such as video analysis, image recognition, object detection, natural language processing, and other upper-layer application platform services.

In this embodiment of this application, a node may be a computer device that includes at least one Graphics Processing Unit (GPU) chip and/or at least one Central Processing Unit (CPU) chip. Each GPU chip includes one or more GPU cores. Each CPU chip includes one or more CPU cores. In this embodiment of this application, a worker module may include one or more GPU cores, and a server module may include one or more CPU cores.

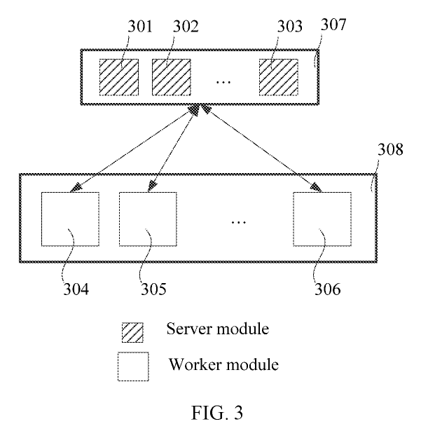

For ease of description, a plurality of server modules may be referred to as a server module set, and a plurality of worker modules may be referred to as a worker module set. FIG. 3 is an example of a schematic diagram of an applicable system architecture according to an embodiment of this application. As shown in FIG. 3, this embodiment of this application includes a server module set 307 and a worker module set 308. The server module set 307 includes a plurality of server modules, which are separately a server module 301, a server module 302, . . . , and a server module 303. The worker module set 308 may include a plurality of worker modules, which are separately a worker module 304, a worker module 305, . . . , and a worker module 306.

A distributed system architecture includes a plurality of distributed nodes. There are three types of specific deployment forms for each node. In a first form, worker modules and server modules are deployed on a same node, and a quantity of the worker modules is the same as or different from a quantity of the server modules. In a second form, worker modules and server modules are respectively deployed on different nodes, and a quantity of the worker modules is the same as or different from a quantity of the server modules. In a third form, worker modules and server modules are deployed on different nodes in a mixed manner. To be specific, at least one of the plurality of nodes includes both worker modules and server modules, and a quantity of the worker modules is the same as or different from a quantity of the server modules. The solution provided in this embodiment of this application is applicable to any specific deployment form.

In this embodiment of this application, one or more server modules and a plurality of worker modules may be used to train a model parameter in a neural network model within a training period.

One training period includes a plurality of iterations. The neural network model includes L layers. L is an integer greater than or equal to 1. Each iterative process includes performing a forward algorithm and a backward algorithm on the L layers. The worker module performs the forward algorithm and the backward algorithm, and obtains, through calculation, a local gradient of the model parameter in the neural network model. Subsequently, the worker module uploads the local gradient of the model parameter to the server module. The server module calculates a global gradient of each model parameter, and the global gradient is pulled from the server module to each worker module. Each worker module updates each model parameter based on the obtained global gradient of each model parameter, and performs a next iteration based on the updated model parameters. The neural network model includes a plurality of layers, and the forward algorithm of calculation from a first layer to an L^{th} layer may be performed during training of the neural network module. In an embodiment, during calculation of the first layer, initial training data is used as input data for training. Subsequently, output data of an upper layer of each layer is used as input data of the layer for training. Optionally, during training of the neural network module, alternatively, the backward algorithm of calculation from the L^{th} layer to the first layer may be performed. In an embodiment, during calculation of the L^{th} layer, output data of the L^{th} layer in the forward algorithm is used as input data of the L^{th} layer in the backward algorithm for training. Subsequently, output data of a lower layer of each layer is used as input data of the layer for training.

In a specific implementation, the L layers included in the neural network model are, for example, various types of layers including a convolutional layer, a fully connected layer, and a batch normalized layer. Features of the types of layers differ greatly. For example, a convolutional layer at the bottom usually has relatively fewer model parameters, and a quantity of the model parameters is at a megabit level (MB level). However, an amount of output data of the layer is very large, and the amount of the output data is at a level of hundreds of MBs. A convolutional layer relatively at top and a fully connected layer usually have a relatively large quantity of model parameters, at a level of hundreds of MBs usually, but have a relatively small amount of output data, at a level of 10 KB to the MB level usually. Based on this, this embodiment of this application provides the following solutions, such that different training solutions are used for features of different layers, thereby reducing a communication volume between the worker module and the server module. Further, because a communication speed between the worker module and the server module is low, an information communication volume between the worker module and the server module becomes a key factor of a speed of training the neural network model. In this embodiment of this application, the communication volume between the worker module and the server module is reduced, thereby greatly increasing the speed of training the neural network model. Based on the foregoing description, the following describes the solutions provided in the embodiments of this application in detail.

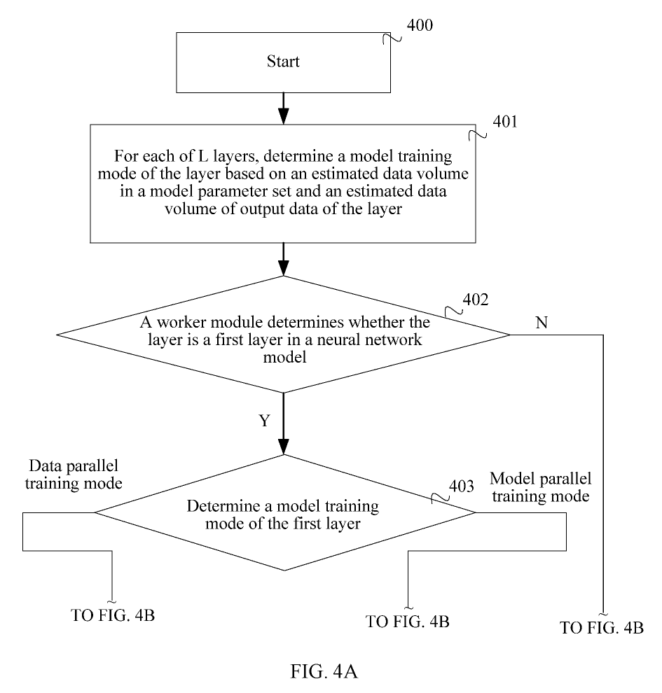

Based on the foregoing content, FIG. 4A and FIG. 4B are an example of a schematic flowchart of a training method for a neural network model according to an embodiment of this application. The method is applied to a training system that includes M worker modules. The neural network model includes L layers. M and L are integers greater than or equal to 1. For each of the L layers of the neural network model, at least one of the M worker modules is used to train the layer. As shown in FIG. 4A and FIG. 4B, the method includes the following steps.

Step 400. Start to perform the following process for each of the L layers of the neural network model.

Step 401. For each of the L layers of the neural network model, each of the at least one worker module determines a model training mode of the layer based on an estimated data volume in a model parameter set and an estimated data volume of output data of the layer, where the model training mode includes a data parallel training mode and a model parallel training mode, and the model parameter set includes all model parameters of the layer.

In a specific training process, each of the at least one worker module performs the following operations to train the layer.

Step 402. The worker module determines whether the layer is a first layer in the neural network model, and if the layer is the first layer in the neural network model, performs step 403; or if the layer is a j^{th} layer in the neural network model, performs step 406.

Step 403. The worker module determines a model training mode of the first layer based on an estimated data volume in a model parameter set and an estimated data volume of output data of the first layer, where the model training mode includes a data parallel training mode and a model parallel training mode; and if the data parallel training mode is used for the first layer, performs step 404; or if the model parallel training mode is used for the first layer, performs step 405.

Step 404. The worker module uses first input data as input data of the first layer, and performs data parallel training on a model parameter of the first layer, where the first input data is initial training data corresponding to the worker module.

Step 405. The worker module uses second input data as input data of the first layer of the worker module, and performs model parallel training on a model parameter of the first layer, where the second input data is initial training data corresponding to the at least one worker module.

Step 406. The worker module determines a model training mode of the j^{th} layer based on an estimated data volume in a model parameter set and an estimated data volume of output data of the j^{th} layer, where the model parameter set includes all model parameters of the j^{th} layer; and if the data parallel training mode is used for the j^{th} layer, performs step 407; or if the model parallel training mode is used for the j^{th} layer, performs step 408.

Step 407. The worker module uses first output data as input data of the j^{th} layer, and performs data parallel training on a model parameter of the j^{th} layer, where the first output data is output data obtained by the worker module by training a (j−1)^{th} layer.

th Step 408. The worker module uses second output data as input data of the j^{th} layer, and performs model parallel training on a model parameter of the j^{th} layer, where the second output data is output data obtained by m worker modules by training a (j−1)^{th} layer, the m worker modules are one or more worker modules used for training the (j−1)^{th} layer, m is an integer greater than or equal to 1 and less than or equal to M, and a value of m of at least one of the L layers is greater than 1. Optionally, in step 408, m may be a total quantity of all of the at least one worker module used for training the (j−1)^{th} layer, or an integer that is greater than or equal to 1 and that is less than a total quantity of all of the at least one worker module used for training the (j−1)^{th} layer.

Optionally, in this embodiment of this application, the neural network model may be optionally trained using a forward algorithm of calculation from the first layer to an L^{th} layer, or may be optionally trained using both a forward algorithm of calculation from the first layer to an L^{th} layer and a backward algorithm of calculation from the L^{th} layer to the first layer.

In a specific implementation, optionally, if the backward algorithm of calculation from the L^{th} layer to the first layer is performed, when the layer is the L^{th} layer in the neural network model, if the data parallel training mode is used for the L^{th} layer, the worker module uses third input data as input data of the L^{th} layer, and performs data parallel training on a model parameter of the L^{th} layer, where the third input data is output data that is of the L^{th} layer in the forward algorithm and that corresponds to the worker module; or if the model parallel training mode is used for the L^{th} layer, the worker module uses fourth input data as input data of the L^{th} layer of the worker module, and performs model parallel training on a model parameter of the L^{th} layer, where the fourth input data is output data obtained by the at least one worker module by training the model parameter of the L^{th} layer in the forward algorithm.

If the backward algorithm of calculation from the L^{th} layer to the first layer is performed, and j is an integer greater than or equal to 1 and less than L, when the layer is a j^{th} layer in the neural network model, if the data parallel training mode is used for the j^{th} layer, the worker module uses third output data as input data of the j^{th} layer, and performs data parallel training on a model parameter of the j^{th} layer, where the third output data is output data obtained by the worker module by training a (j+1)^{th} layer; or if the model parallel training mode is used for the j^{th} layer, the worker module uses fourth output data as input data of the j^{th} layer, and performs model parallel training on a model parameter of the j^{th} layer, where the fourth output data is output data obtained by m worker modules by training a (j+1)^{th} layer, the m worker modules are one or more worker modules used for training the (j+1)^{th} layer, m is an integer greater than or equal to 1 and less than or equal to M, and a value of m of at least one of the L layers is greater than 1.

In this embodiment of this application, the foregoing method steps may be performed by each of the at least one worker module that trains the layer. A management module is configured in the worker module performing the foregoing method. Optionally, step 402 may be performed by each of the at least one worker module that trains the layer or may be performed by one of the at least one worker module that trains the layer and that has the management module. Subsequently, a result (for example, the model training mode of each layer) is notified to each of the at least one worker module that trains the layer. Alternatively, step 402 is performed by one of the M worker modules that has a management module other than the at least one worker module that trains the layer. Subsequently, a result (for example, the model training mode of each layer) is notified to each of the at least one worker module that trains the layer.

In this embodiment of this application, the M worker modules and the server modules may be located on a same node. The node is a computer device that includes a plurality of GPU cores and a plurality of CPU cores. One worker module includes one or more GPU cores, and one server module includes one or more CPU cores. In this case, the M worker modules may communicate with each other through an electrical connection between the GPU cores, and the M worker modules may communicate with the server modules through inter-core communication between the GPU cores and the CPU cores. If the M worker modules and the server modules are separately located on a plurality of nodes, communication between the M worker modules or between the M worker modules and the server modules may be implemented through electrical connections or inter-core connections within the nodes, or using some links between the nodes. In an implementation, any two of the M worker modules in this embodiment of this application can implement communication, and each of the M worker modules can communicate with the server modules.

In an embodiment, before at least one of the M worker modules trains the first layer, initial training data is configured for each of the at least one worker module that trains the first layer. The initial training data corresponding to each worker module may be different data or same data, such that the worker module and the server modules cooperate to train the model parameter in the neural network model. For example, if there are 100 pictures, and a quantity of the at least one worker module that trains the first layer is 10, optionally, each worker module is allocated 10 pictures. The 10 pictures allocated to each worker module are referred to as initial training data configured for the worker module.

In this embodiment of this application, for each layer, a value obtained after a worker module that trains the layer performs the forward algorithm and the backward algorithm based on input data and a model parameter is referred to as a gradient. For a layer corresponding to the data parallel training mode, the worker module uses initial training data corresponding to the worker module as input data, or the worker module uses the output data obtained by the worker module by training an upper layer as input data of the layer. In other words, for the layer corresponding to the data parallel training mode, the input data used by the worker module is local input data. In this case, training is performed based on the input data and the model parameter, and an obtained result is referred to as a local gradient. For a layer corresponding to the model parallel training mode, the worker module uses all initial training data corresponding to the at least one worker module that trains the layer as input data, or the worker module uses all output data of at least one worker module that trains an upper layer as input data of the layer. In other words, for the layer corresponding to the model parallel training mode, the input data used by the worker module is global input data. In this case, training is performed based on the input data and the model parameter, and an obtained result is referred to as a global gradient. Optionally, for each layer, if the worker module obtains a local gradient through calculation, the worker module pushes the local gradients to a server module which calculates a global gradient based on the plurality of received local gradients. Then the worker module pulls the global gradient from the server module, and updates the local model parameter based on the global gradient, for use during a next iteration. If the worker module obtains a global gradient through calculation, the worker module updates the local model parameter based on the global gradient obtained through calculation, for use during a next iteration.

In this embodiment of this application, the model training mode of each layer is determined based on the estimated data volume in the model parameter set and the estimated data volume of the output data of the layer. In this way, if the model parallel training mode is used for the j^{th} layer, the worker module uses the second output data as the input data of the j^{th} layer, and performs the model parallel training on the model parameter of the j^{th} layer. The second output data is the output data obtained by the m worker modules by training the (j−1)^{th} layer. To be specific, for the j^{th} layer corresponding to the model parallel training mode, the worker module receives the output data of the m worker modules. The data may be referred to as full data. The worker module may directly obtain the global gradient of the model parameter by training the model parameter based on the full data. Compared with a prior art solution in which a worker module pushes a local gradient of a model parameter to a server module and pulls a global gradient of the model parameter from the server module to obtain the global gradient of the model parameter, this embodiment of this application reduces the communication volume between the worker module and the server module.

Further, during training of the neural network module, communication between the worker module and the server module takes a relatively long time. Therefore, as the communication volume between the worker module and the server module in this embodiment of this application decreases, a speed of training the neural network model in this embodiment of this application increases accordingly.

Further, because a communication speed between the worker module and the server module is low, an information communication volume between the worker module and the server module becomes a key factor of the speed of training the neural network model. In this embodiment of this application, the communication volume between the worker module and the server module is reduced, thereby greatly increasing the speed of training the neural network model.

Further, this embodiment of this application is applied to the system architecture that includes the server modules and the M worker modules. Because parallel computing can be performed on a distributed architecture, a speed of iterative calculation in the neural network model can be increased, thereby reducing a duration of training the neural network model. Further, parallel acceleration is performed on matrix calculation using a GPU chip in the distributed system architecture, thereby further increasing the speed of iterative calculation in the neural network model, and further reducing the duration of training the neural network model.

Each layer in the neural network model corresponds to a feature parameter. Therefore, the estimated data volume in the model parameter set and the estimated data volume of the output data of each layer can be determined based on the feature parameter of the layer. Subsequently, the model training mode of the layer is determined based on the estimated data volume in the model parameter set and the estimated data volume of the output data of the layer. After the determining, the neural network model is trained directly based on the determined model training mode of each layer in the forward algorithm and the backward algorithm.

Optionally, the determining a model training mode of the layer based on an estimated data volume in a model parameter set and an estimated data volume of output data of the layer includes, when the estimated data volume in the model parameter set is not greater than the estimated data volume of the output data of the layer, determining that the model training mode of the layer is the data parallel training mode; or when the estimated data volume in the model parameter set is greater than the estimated data volume of the output data of the layer, determining that the model training mode of the layer is the model parallel training mode.

For example, the L layers included in the neural network model are, for example, various types of layers including a convolutional layer, a fully connected layer, and a batch normalized layer. Each type of layer corresponds to a particular feature. Each type of layer includes some feature parameters. For example, a convolutional layer at the bottom usually has relatively fewer model parameters, and a quantity of the model parameters is at a megabit level (MB level). However, an amount of output data of the layer is very large, and the amount of the output data is at a level of hundreds of MBs. The estimated data volume in the model parameter set of the layer is at the MB level, and the estimated data volume of the output data of the layer is at the level of hundreds of MBs. Based on this, the model training mode of the layer is determined. Optionally, because the estimated data volume of the output data is at the level of hundreds of MBs, and is greater than the estimated data volume, being at the MB level, in the model parameter set of the layer, it is determined that the data parallel training mode is used for the layer.

For still another example, a convolutional layer relatively at top and a fully connected layer usually have a relatively large quantity of model parameters, at a level of hundreds of MBs usually, but have a relatively small amount of output data, at a level of 10 KB to an MB level usually. The estimated data volume in the model parameter set of the layer is at the level of hundreds of MBs, and the estimated data volume of the output data of the layer is at the level of 10 KB to the MB level. Based on this, the model training mode of the layer is determined. Optionally, because the estimated data volume of the output data is at the level of 10 KB to the MB level, and is less than the estimated data volume, being at the level of hundreds of MBs, in the model parameter set of the layer, it is determined that the model parallel training mode is used for the layer.

In a specific implementation, the data parallel training mode is used for a layer whose estimated data volume of output data is relatively large. In the data parallel training mode, the worker module uses output data of a layer as input data of a next layer in the neural network model. The worker module pushes the local gradient of the model parameter to the server module, and pulls the global gradient of the model parameter from the server module. Because the estimated data volume in the model parameter set of the layer corresponding to the data parallel training mode is relatively small, the communication volume transmitted between the worker module and the server module is relatively small. In this embodiment of this application, the estimated data volume in the model parameter set is a data volume that is in the model parameter set and that includes all the model parameters.

Correspondingly, the model parallel training mode is used for a layer whose estimated data volume in a model parameter set is relatively large. In the model parallel training mode, the worker module may directly obtain a global gradient of a model parameter by training the model parameter based on the full data. Therefore, compared with the prior art solution in which a worker module pushes a local gradient of a model parameter to a server module, and pulls a global gradient of the model parameter from the server module to obtain the global gradient of the model parameter, this embodiment of this application greatly reduces the communication volume between the worker module and the server module.

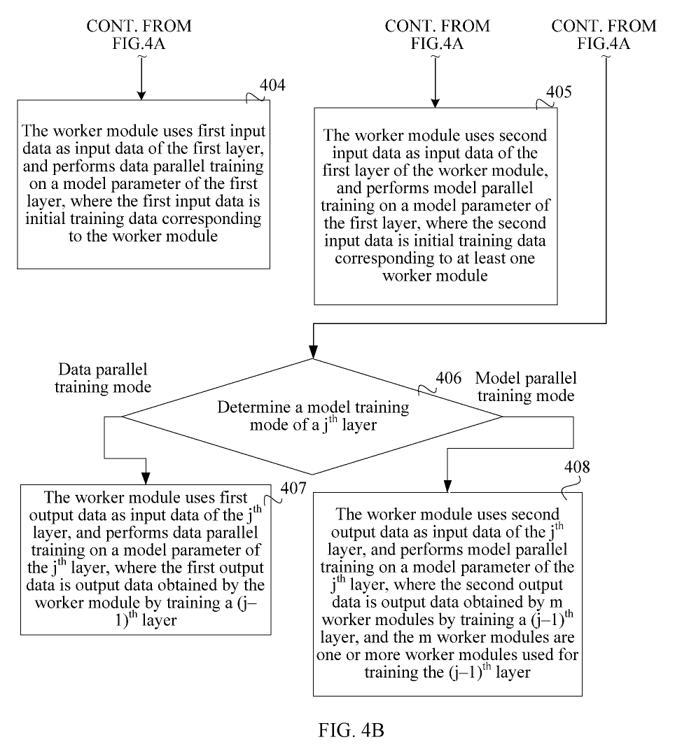

FIG. 5 is an example of a schematic flowchart of a method for determining a value of a quantity of at least one worker module used for training a j^{th} layer according to an embodiment of this application. As shown in FIG. 5, optionally, if a model parallel training mode is used for the j^{th} layer, before a worker module uses second output data as input data of the j^{th} layer, and performs model parallel training on a model parameter of the j^{th} layer, the method further includes determining a value of a quantity of at least one worker module used for training the j^{th} layer. There are a plurality of specific solutions. This embodiment of this application provides the following solution, including the following steps.

Step A. Set a value of i to an integer greater than or equal to 1 and less than or equal to M, estimate a first total duration spent by i worker modules on training, and perform step B, where the first total duration is an estimated total duration spent by all of the i worker modules on receiving second input data and training the model parameter of the j^{th} layer based on the second input data.

Step B. Update the value of i, where the updated value of i is another integer greater than or equal to 1 and less than or equal to M, and perform step C.

Step C. Estimate a second total duration spent by updated i worker modules on training, where the second total duration is an estimated total duration spent by all of the updated i worker modules on receiving the second input data and training the model parameter of the j^{th} layer based on the second input data, where each value of i corresponds to one total duration; and if a sum of a quantity of first total durations and a quantity of second total durations is less than a quantity threshold, perform step B; or if a sum of a quantity of first total durations and a quantity of second total durations is equal to a quantity threshold, perform step D. Optionally, the quantity threshold is a preset value, and may be, for example, 2, or 3. This may be determined based on experience and a specific implementation condition.

Step D. Determine a total duration with a smaller value in the first total duration and the second total duration, and use a value that is of i and that corresponds to the total duration with a smaller value as the determined value of the quantity of the at least one worker module used for training the j^{th} layer.

In this embodiment of this application, a distributed architecture includes M worker modules. For the j^{th} layer for which the model parallel training mode is used, a larger quantity of at least one worker module used for training the model parameter of the j^{th} layer indicates a shorter duration of model training of the j^{th} layer. However, worker modules used for performing model parameter training on the (j−1)^{th} layer all need to output data of the (j−1)^{th} layer to all worker modules training the j^{th} layer. Therefore, a larger quantity of at least one worker module used for training the model parameter of the j^{th} layer indicates a longer duration of transmitting the output data of the (j−1)^{th} layer to the worker modules training the model parameter of the j^{th} layer. Therefore, a trade-off is found between training of the layer by the worker module and transmission of the input data in this embodiment of this application, to reduce as much as possible a sum of a training duration that is of the layer and that corresponds to the determined quantity of worker modules that train the model parameter of the j^{th} layer and a transmission duration of the input data.

Optionally, the determined value of the quantity of the at least one worker module used for training the j^{th} layer is described using a forward algorithm as an example. In this embodiment of this application, alternatively a backward algorithm may be used to determine the value of the quantity of the at least one worker module used for training the j^{th} layer. When the backward algorithm is used for calculation, a solution is similar to the foregoing content, but the first total duration is an estimated total duration spent by all of the i worker modules on receiving fourth input data and training the model parameter of the j^{th} layer based on the fourth input data, and the second total duration is an estimated total duration spent by all of the updated i worker modules on receiving the fourth input data and training the model parameter of the j^{th} layer based on the fourth input data. A remaining processing solution is similar to the foregoing solution, and is not described in detail herein.

This embodiment of this application provides an optional implementation solution. The forward algorithm is used as an example. Values from 1 to M are traversed and set for i, and for each value of i, a total duration spent by the i worker modules on training the model parameter of the j^{th} layer is calculated, to obtain one first total duration and M−1 second total durations. A value that is of i and that corresponds to a smallest value of the first total duration and the M−1 second total durations is determined as the value of the quantity of the at least one worker module used for training the j^{th} layer.

When the forward algorithm is used, optionally, if the model parallel training mode is used for the j^{th} layer, the using, by the worker module, second output data as input data of the j^{th} layer, and performing model parallel training on a model parameter of the j^{th} layer includes determining, by the worker module based on a model parameter set of the j^{th} layer, a model parameter subset that is of the j^{th} layer and that is to be trained by the worker module; and using, by the worker module, the second output data as the input data of the j^{th} layer, and performing the model parallel training on the model parameter subset of the j^{th} layer. An intersection set between model parameter subsets of the j^{th} layer that are trained by any two of the at least one worker module is empty. A union set of model parameter subsets of the j^{th} layer that are trained by all of the at least one worker module is equal to a universal set of model parameters of the j^{th} layer. In this way, a model parameter subset is allocated to each of the m worker modules that trains the layer. Therefore, all of the m worker modules are used to train the model parameter subsets, thereby increasing a speed of training the model parameter. Another optional implementation solution is to equally allocate all the model parameters of the layer to the m worker modules.

When the backward algorithm is used, optionally, if the model parallel training mode is used for the j^{th} layer, using, by the worker module, fourth output data as input data of the j^{th} layer, and performing model parallel training on a model parameter of the j^{th} layer includes determining, by the worker module based on a model parameter set of the j^{th} layer, a model parameter subset that is of the j^{th} layer and that is to be trained by the worker module; and using, by the worker module, the fourth output data as the input data of the j^{th} layer, and performing the model parallel training on the model parameter subset of the j^{th} layer. An intersection set between model parameter subsets of the j^{th} layer that are trained by any two of the at least one worker module is empty. A union set of model parameter subsets of the j^{th} layer that are trained by all of the at least one worker module is equal to a universal set of model parameters of the j^{th} layer.

In a specific implementation, determining the quantity m of the at least one worker module training the j^{th} layer and allocating a model parameter subset to each of the at least one worker module may be separately performed by each of the at least one worker module training the j^{th} layer. In addition, during the performing, the worker modules may communicate with each other to negotiate the quantity m of the at least one worker module training the j^{th} layer and the model parameter subset of each worker module. A management module is configured in each worker module. Alternatively, the foregoing operations may be performed by any of the M worker modules, and then a notification is sent to each of the at least one worker module training the j^{th} layer.

For example, the j^{th} layer is a layer corresponding to the model parallel training mode, and the quantity m of the at least one worker module training the j^{th} layer is 3. In this case, three worker modules may be randomly selected from the M worker modules to train the model parameter of the layer. An estimated data volume in a model parameter set of the layer is 300 MB. Model parameters of 300 MB are allocated to the three worker modules. For example, a model parameter of 100 MB is allocated to each worker module. The model parameter of 100 MB allocated to each worker module is a model parameter subset corresponding to the worker module.

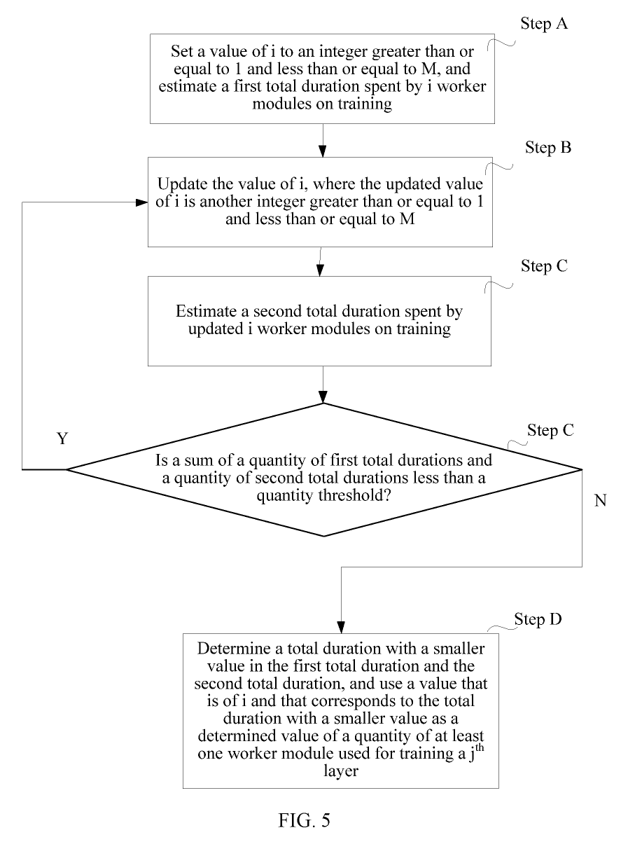

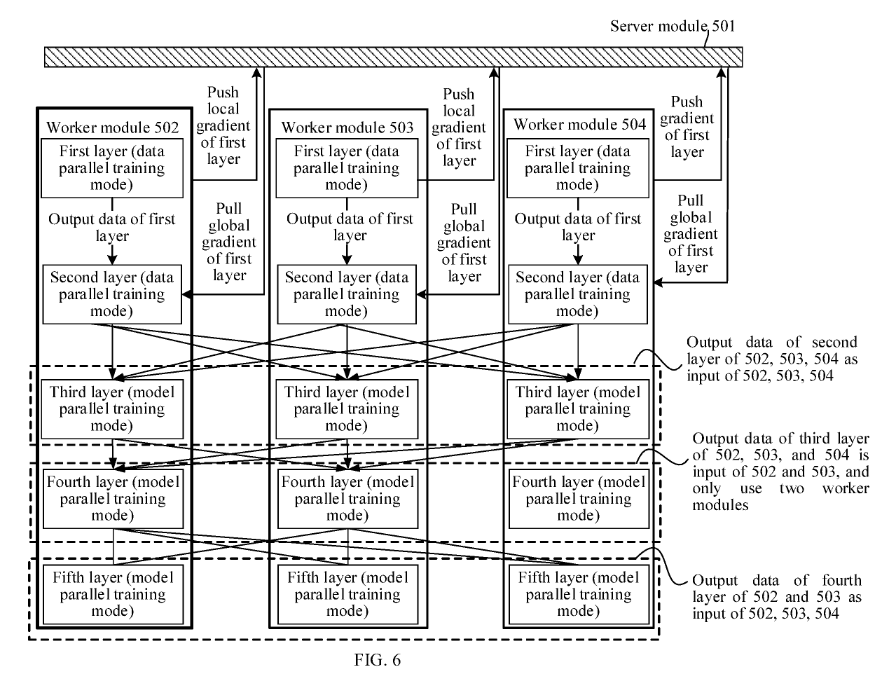

To further describe the embodiments of this application, FIG. 6 and FIG. 7 are each an example of a schematic flowchart of a training method for a neural network model according to an embodiment of this application. As shown in FIG. 6 and FIG. 7, a server module 501 and three worker modules are included. In other words, M is 3. The three worker modules are a worker module 502, a worker module 503, and a worker module 504. In this example, the neural network model includes five layers. In other words, L is 5.

A model training mode of each layer is determined based on the foregoing solution. In an embodiment, the model training mode of each layer is determined based on an estimated data volume in a model parameter set and an estimated data volume of output data of each layer. For example, it is determined that a data parallel training mode is used for a first layer and a second layer, and a model parallel training mode is used for a third layer to a fifth layer.

Further, a quantity of worker modules performing model training on a layer corresponding to the model parallel training mode and a negotiated worker module for training each layer are determined based on the foregoing solution. Optionally, for a layer corresponding to the data parallel training mode, because a worker module for performing model training on the layer corresponding to the data parallel training mode receives data that is output by the worker module after training an upper layer. Therefore, for the layer corresponding to the data parallel training mode, a larger quantity of worker modules training the layer indicates a shorter duration spent on training the layer. Optionally, in this embodiment of this application, it is determined that M worker modules train the layer corresponding to the data parallel training mode.

Optionally, for the layer corresponding to the model parallel training mode, a quantity of worker modules performing model training on each layer may be determined based on the solution related to FIG. 5. For example, in the foregoing solution, it is determined, in this example, that a quantity of worker modules training a model parameter of the third layer is three, a quantity of worker modules training a model parameter of the fourth layer is two, and a quantity of worker modules training a model parameter of the fifth layer is 3.

For the layer corresponding to the model parallel training mode, it is further determined, based on the foregoing solution, a model parameter subset corresponding to each worker module performing model training on the layer. In other words, for the layer corresponding to the model parallel training mode, all model parameters in a model parameter set of the layer are allocated to the worker module performing model parameter training on the layer. For example, all model parameters of the third layer are allocated to the worker module 502, the worker module 503, and the worker module 504. All model parameters included in a model parameter set of the fourth layer are allocated to the worker module 502 and the worker module 503. The worker module 502 and the worker module 503 respectively correspond to one model parameter subset of the fourth layer. All model parameters in a model parameter set of the fifth layer are allocated to the worker module 502, the worker module 503, and the worker module 504. The worker module 502, the worker module 503, and the worker module 504 respectively correspond to one model parameter subset of the fifth layer.

Further, in this embodiment of this application, for the data parallel training mode, input data of a worker module training the layer corresponding to the data parallel training mode is first input data or first output data. Input data of a worker module training the layer corresponding to the model parallel training mode is second input data or second output data. Before a specific training process is performed, in the solution provided in this embodiment of this application, the foregoing information is determined in advance, for direct use in the following training process.

In this embodiment of this application, the worker module and the server module complete training of the neural network model through a plurality of iterations. An iterative process is described in this example. Each iterative process includes a forward algorithm and a backward algorithm. The following first describes the forward algorithm. It should be understood that the description is merely an example, and is not intended to limit the implementation of this application.

As shown in FIG. 6 and FIG. 7, the worker module 502 obtains initial training data allocated to the worker module 502. The initial training data is used as input data of the first layer of the worker module 502. The worker module 502 trains, based on the input data of the first layer, all model parameters included in the first layer, to obtain output data of the first layer, and transmits the output data of the first layer to the second layer of the worker module 502, as input data of the second layer of the worker module 502. Correspondingly, the worker module 503 performs training based on the input data of the first layer, to obtain the output data of the first layer of the worker module 503, and uses the output data of the first layer of the worker module 503 as the input data of the second layer of the worker module 503. The worker module 504 performs training based on the input data of the first layer, to obtain the output data of the first layer of the worker module 504, and uses the output data of the first layer of the worker module 504 as the input data of the second layer of the worker module 504.

The worker module 502 trains, based on the input data of the second layer, all model parameters included in the second layer, to obtain the output data of the second layer, and transmits the output data of the second layer to the third layer of the worker module 502, the worker module 503, and the worker module 504. Correspondingly, the worker module 503 transmits the output data of the second layer to the third layer of the worker module 502, the worker module 503, and the worker module 504. The worker module 504 transmits the output data of the second layer to the third layer of the worker module 502, the worker module 503, and the worker module 504.

The worker module 502 uses the received output data of the second layer of the worker module 502, the worker module 503, and the worker module 504 as the input data of the third layer of the worker module 502. The worker module 502 trains the allocated model parameter based on the input data of the third layer of the worker module 502. In other words, the worker module 502 trains, based on full data, some model parameters allocated to the third layer of the worker module 502, to obtain the output data of the third layer, and transmits the output data of the third layer to the fourth layer of the worker module 502 and the worker module 503. Correspondingly, the worker module 503 uses the received output data of the second layer of the worker module 502, the worker module 503, and the worker module 504 as the input data of the third layer of the worker module 502, and transmits the output data of the third layer to the fourth layer of the worker module 502 and the worker module 503. The worker module 504 uses the received output data of the second layer of the worker module 502, the worker module 503, and the worker module 504 as the input data of the third layer of the worker module 504, and transmits the output data of the third layer to the fourth layer of the worker module 502 and the worker module 503.

The worker module 502 uses the received output data of the third layer of the worker module 502, the worker module 503, and the worker module 504 as the input data of the fourth layer of the worker module 502. The worker module 502 trains the allocated model parameter based on the input data of the fourth layer of the worker module 502. In other words, the worker module 502 trains, based on full data, some model parameters allocated to the fourth layer of the worker module 502, to obtain the output data of the fourth layer, and transmits the output data of the fourth layer to the fifth layer of the worker module 502 and the worker module 503. Correspondingly, the worker module 503 uses the received output data of the third layer of the worker module 502, the worker module 503, and the worker module 504 as the input data of the fourth layer of the worker module 502, and transmits the output data of the fourth layer to the fifth layer of the worker module 502 and the worker module 503. It can be learned that the worker module 504 does not train the model parameter of the fourth layer.

The worker module 502 uses the received output data of the fourth layer of the worker module 502, the worker module 503, and the worker module 504 as the input data of the fifth layer of the worker module 502. The worker module 502 trains the allocated model parameter based on the input data of the fifth layer of the worker module 502. In other words, the worker module 502 trains, based on full data, some model parameters allocated to the fifth layer of the worker module 502, to obtain the output data of the fifth layer. So far, the forward algorithm of the worker module 502 is completed, and the backward algorithm is started. When the backward algorithm is started, the worker module 502 transmits the output data of the fifth layer to the fourth layer of the worker module 502 and the worker module 503. Correspondingly, the worker module 503 uses the received output data of the fourth layer of the worker module 502, the worker module 503, and the worker module 504 as the input data of the fifth layer of the worker module 503, and trains the allocated model parameter based on the input data of the fifth layer of the worker module 503, to obtain the output data of the fifth layer. So far, the forward algorithm of the worker module 503 is completed, and the backward algorithm is started. When the backward algorithm is started, the worker module 503 transmits the output data of the fifth layer to the fourth layer of the worker module 502 and the worker module 503. The worker module 504 uses the received output data of the fourth layer of the worker module 502, the worker module 503, and the worker module 504 as the input data of the fifth layer of the worker module 504, and trains the allocated model parameter based on the input data of the fifth layer of the worker module 504, to obtain the output data of the fifth layer. So far, the forward algorithm of the worker module 504 is completed, and the backward algorithm is started. When the backward algorithm is started, the worker module 504 transmits the output data of the fifth layer to the fourth layer of the worker module 502 and the worker module 503.

After the forward algorithm, the worker module 502 uses the received output data of the fifth layer of the worker module 502, the worker module 503, and the worker module 504 as the input data of the fourth layer of the worker module 502. The worker module 502 trains the allocated model parameter based on the input data of the fourth layer of the worker module 502. In other words, the worker module 502 trains, based on full data, some model parameters allocated to the fourth layer of the worker module 502, to obtain the output data of the fourth layer. The worker module 502 transmits the obtained output data of the fourth layer to the third layer of the worker module 502, the worker module 503, and the worker module 504. Correspondingly, the worker module 503 uses the received output data of the fifth layer of the worker module 502, the worker module 503, and the worker module 504 as the input data of the fourth layer of the worker module 502, and trains the allocated model parameter based on the input data of the fourth layer of the worker module 502, to obtain the output data of the fourth layer. The worker module 503 transmits the obtained output data of the fourth layer to the third layer of the worker module 502, the worker module 503, and the worker module 504.

The worker module 502 uses the received output data of the fourth layer of the worker module 502 and the worker module 503 as the input data of the third layer of the worker module 502. The worker module 502 trains the allocated model parameter based on the input data of the third layer of the worker module 502. In other words, the worker module 502 trains, based on full data, some model parameters allocated to the third layer of the worker module 502, to obtain the output data of the third layer. The worker module 502 transmits the obtained output data of the third layer to the second layer of the worker module 502 as the input data of the second layer of the worker module 502. Correspondingly, the worker module 503 trains the allocated model parameter based on the received output data of the fourth layer of the worker module 502 and the worker module 503, to obtain the output data of the third layer, and transmits the obtained output data of the third layer to the second layer of the worker module 503, as the input data of the second layer of the worker module 503. The worker module 504 trains the allocated model parameter based on the received output data of the fourth layer of the worker module 502 and the worker module 503, to obtain the output data of the third layer, and transmits the obtained output data of the third layer to the second layer of the worker module 504, as the input data of the second layer of the worker module 504.

The worker module 502 uses the output data of the third layer of the worker module 502 as the input data of the second layer, trains all model parameters of the second layer, to obtain a local gradient of the model parameter of the second layer, and pushes the local gradient to the server module 501. In the distributed architecture, the worker module 503 working in parallel with the worker module 502 trains all the model parameters of the second layer based on the input data of the second layer, to obtain the local gradient of the model parameter of the second layer, and pushes the local gradient to the server module 501. The worker module 504 trains all the model parameters of the second layer based on the input data of the second layer, to obtain the local gradient of the model parameter of the second layer, and pushes the local gradient to the server module 501. The server module 501 calculates a global gradient of the model parameter of the second layer based on the received local gradients separately reported by the three worker modules. Each worker module pulls the global gradient of the model parameter of the second layer from the server module 501.

Similarly, the worker module 502 uses the output data of the second layer of the worker module 502 as the input data of the first layer, trains all model parameters of the first layer, to obtain a local gradient of the model parameter of the first layer, and pushes the local gradient to the server module 501. In the distributed architecture, the worker module 503 pushes the local gradient of the model parameter of the first layer to the server module 501. The worker module 504 pushes the local gradient of the model parameter of the first layer to the server module 501. The server module 501 calculates a global gradient of the model parameter of the first layer based on the received local gradients of the model parameter of the first layer that are separately reported by the three worker modules. Each worker module pulls the global gradient of the model parameter of the first layer from the server module 501.

In the foregoing example, the worker module 502, the worker module 503, and the worker module 504 operate in parallel. For example, the worker module 502, the worker module 503, and the worker module 504 may train the model parameter of the first layer in parallel. It can be learned that the distributed architecture increases a speed of training the neural network model. For the layer corresponding to the data parallel training mode, the worker module uses the forward algorithm and the backward algorithm, pushes the local gradient to the server module, and pulls the global gradient from the server module, to obtain the global gradient of the model parameter of the layer corresponding to data parallel training mode. For the layer corresponding to the model parallel training mode, the worker module uses the forward algorithm and the backward algorithm. Because each worker module trains the model parameter based on the full data of the upper layer of the layer, the global gradient that is of the model parameter and that is obtained through calculation by the worker module is the global gradient that is of the model parameter of the layer and that is allocated to the worker module. It can be learned that for the layer corresponding to the model parallel training mode, the worker module does not need to push the local gradient to the server module and then pull the global gradient to obtain the global gradient of the model parameter, thereby reducing a communication volume in a system.

Based on the foregoing example, to further increase the speed of training the neural network model, this embodiment of this application provides an optional solution. If the forward algorithm of calculation from the first layer to the L^{th} layer is used, and j is an integer greater than 1 and less than or equal to L, input data of each model parallel layer of each worker module is divided into a first input data subblock and a second input data subblock. If the model parallel training mode is used for the j^{th} layer, the second output data is divided into a first input data subblock and a second input data subblock. If the model parallel training mode is used for the j^{th} layer, the using, by the worker module, second output data as input data of the j^{th} layer, and performing model parallel training on a model parameter of the j^{th} layer includes receiving, by the worker module, the first input data subblock; performing in parallel, by the worker module, the following steps. For instance, performing the model parallel training on the model parameter of the j^{th} layer based on the first input data subblock, to obtain first output subdata of the j^{th} layer, and receiving the second input data subblock; and performing in parallel, by the worker module, the following steps. For instance, performing the model parallel training on the model parameter of the j^{th} layer based on the second input data subblock, to obtain second output subdata of the j^{th} layer, and transmitting the first output subdata of the j^{th} layer to a (j+1)^{th} layer. A communication process of a communications module and a training process of a training module are performed in parallel. In other words, the training process and the communication process are performed in parallel, thereby increasing a speed of training the neural network model.

If the backward algorithm of calculation from the L^{th} layer to the first layer is performed, j is an integer greater than or equal to 1 and less than L, and the model parallel training mode is used for the j^{th} layer, the fourth output data is divided into a third input data subblock and a fourth input data subblock. If the model parallel training mode is used for the j^{th} layer, the using, by the worker module, fourth output data as input data of the j^{th} layer, and performing model parallel training on a model parameter of the j^{th} layer includes receiving, by the worker module, the third input data subblock; performing in parallel, by the worker module, the following steps. For instance, performing the model parallel training on the model parameter of the j^{th} layer based on the third input data subblock, to obtain third output subdata of the j^{th} layer, and receiving the fourth input data subblock; and performing in parallel, by the worker module, the following steps. For instance, performing the model parallel training on the model parameter of the j^{th} layer based on the fourth input data subblock, to obtain the fourth output subdata of the j^{th} layer, and transmitting the third output subdata of the j^{th} layer to a (j−1)^{th} layer.

This embodiment of this application provides an optional solution. For example, in FIG. 6 and FIG. 7, one or more consecutive layers corresponding to the data parallel training mode are used as a training layer, and each layer corresponding to the model parallel training mode is used as a training layer. In FIG. 6 and FIG. 7, because the first layer and the second layer are consecutive, and both are layers corresponding to the data parallel training mode, the first layer and the second layer may be referred to as a training layer, and are referred to as a first training layer in this embodiment of this application. The third layer is referred to as a second training layer, the fourth layer is referred to as a third training layer, and the fifth layer is referred to as a fourth training layer.

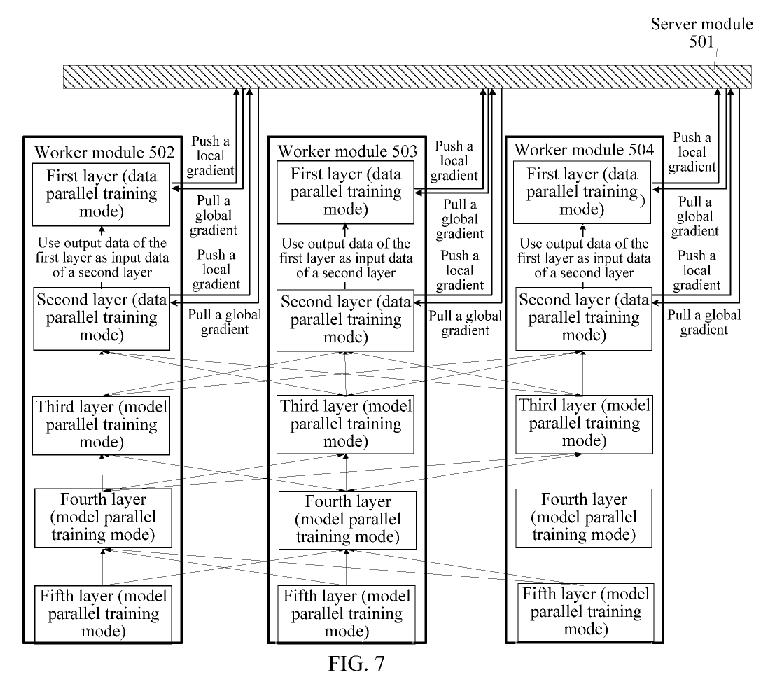

In this embodiment of this application, for each training layer, input data of the training layer is divided into a first input data subblock and a second input data subblock. To be specific, in this embodiment of this application, input data of each layer corresponding to the model parallel training mode is divided into a first input data subblock and a second input data subblock. Optionally, input data of a layer corresponding to the data parallel training mode is divided into a first input data subblock and a second input data subblock. FIG. 8 is an example of a schematic diagram of a method for a forward algorithm for a third layer and a fourth layer in FIG. 7. As shown in FIG. 8, for each worker module, the input data that is of the third layer and that corresponds to each worker module is divided into a first input data subblock and a second input data subblock. The worker module 502 may perform training based on the first input data subblock first, and after obtaining the first output subdata, perform two actions in parallel. A first action is transmitting the first output subdata to the fourth layer of the worker module 502 and the fourth layer of the worker module 503. The other action is performing training based on the second input data subblock of the third layer. The parallel execution of the foregoing two actions may be started at the same time or may not be started at the same time. This is considered as the parallel execution described in this embodiment of this application, provided that time windows of the two actions overlap. Correspondingly, functions of the worker module 503 and the worker module 504 are similar to the functions of the worker module 502, and are not described in detail herein. A solution of the backward algorithm is similar to the solution of the forward algorithm in this embodiment of this application, and is not described in detail herein.

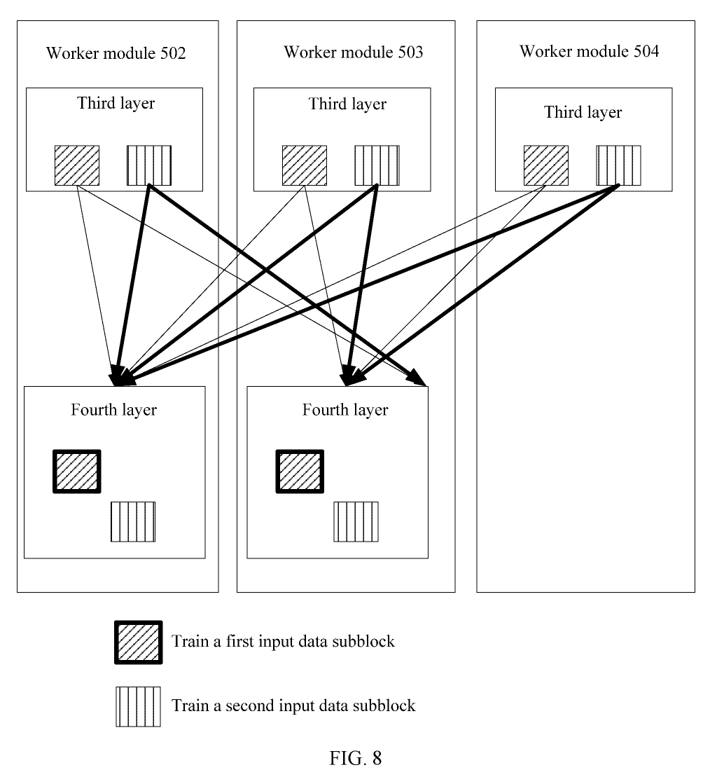

FIG. 9 is an example of a schematic diagram of a work process of the worker module 502 in FIG. 6 to FIG. 8. As shown in FIG. 9, the worker module 502 includes a training module and a communications module. In this embodiment of this application, each worker module may include the training module and the communications module. The training module and the communications module may operate in parallel. The forward algorithm is used as an example. The training module of the worker module 502 performs training based on the first input data subblock of the first training layer, and obtains an output result of the first input data subblock of the first training layer.

The worker module 502 performs two actions in parallel. For instance, performing, by the training module of the worker module 502, training based on the second input data subblock of the first training layer, and obtaining an output result of the second input data subblock of the first training layer; and transmitting, by the communications module of the worker module 502, the output result of the first input data subblock of the first training layer to the second training layer of the worker module 502, the worker module 503, and the worker module 504. Other worker modules also perform in parallel actions similar to those of the worker module 502. The worker module 502 uses received output results that are of the first input data subblock of the first training layer and that are separately output by the worker module 502, the worker module 503, and the worker module 504 as the first input data subblock of the second training layer.

The worker module 502 subsequently performs two actions in parallel. For instance, performing, by the training module of the worker module 502, training based on the first input data subblock of the second training layer, and obtaining an output result of the first input data subblock of the second training layer; and transmitting, by the communications module of the worker module 502, the output result of the second input data subblock of the first training layer to the second training layer of the worker module 502, the worker module 503, and the worker module 504. Other worker modules also perform in parallel actions similar to those of the worker module 502. The worker module 502 uses received output results that are of the second input data subblock of the first training layer and that are separately output by the worker module 502, the worker module 503, and the worker module 504 as the second input data subblock of the second training layer.

The worker module 502 subsequently performs two actions in parallel. For instance, performing, by the training module of the worker module 502, training based on the second input data subblock of the second training layer, and obtaining an output result of the second input data subblock of the second training layer; and transmitting, by the communications module of the worker module 502, the output result of the first input data subblock of the second training layer to the third training layer of the worker module 502, the worker module 503, and the worker module 504. Other worker modules also perform in parallel actions similar to those of the worker module 502. The worker module 502 uses received output results that are of the first input data subblock of second training layer and that are separately output by the worker module 502, the worker module 503, and the worker module 504 as the first input data subblock of the third training layer. Content for other training layers is similar to the foregoing content, and is not described in detail herein.

It can be learned from the foregoing content that in this embodiment of this application, a total duration spent by i worker modules on training the model parameter of the layer includes a duration spent by the i worker modules on transmitting the input data and a duration spent by the i worker modules on training the model parameter of the layer. In an embodiment, for example, for the third layer in this embodiment of this application, a total duration spent by three worker modules on training the model parameter of the layer includes a duration spent by the three worker modules on transmitting the input data, and a duration spent by the three worker modules on training the model parameter of the layer. The duration spent by the three worker modules on transmitting the input data is the duration spent by the worker module 502, the worker module 503, and the worker module 504 on separately inputting the output result of the second layer to the three worker modules in FIG. 6 and FIG. 7.

It can be learned from FIG. 9 that, in this embodiment of this application, the input data of the layer corresponding to the model parallel training mode is divided into the first input data subblock and the second input data subblock. In this way, for each layer, a time for training a model parameter and a time for transmitting data overlap. This embodiment of this application provides a solution with reference to FIG. 9. A total duration t spent by the m worker modules on separately receiving the second input data and training the model parameter of the j^{th} layer based on the second input data is estimated in the following manner.

t=max{t1, t3}+max{t2, t3} (1)

t1 is a duration spent by the m worker modules on receiving the second input data subblock; t2 is a duration spent by the m worker modules on transmitting the first output subdata of the j^{th} layer to the (j+1)^{th} layer; and t3 is a duration spent by the m worker modules on performing the model parallel training on the model parameter of the j^{th} layer based on the first input data subblock to obtain the first output subdata of the j^{th} layer; or t3 is a duration spent by the m worker modules on performing the model parallel training on the model parameter of the j^{th} layer based on the second input data subblock to obtain the second output subdata of the j^{th} layer.

Optionally, t is the first total duration or the second total duration in the foregoing content.

With reference to FIG. 9, for example, the total duration t spent by the m worker modules on training the third layer (namely, the second training layer) meets the foregoing formula (1). t1 is a duration spent by the m worker modules on receiving the second output subdata of the second layer that is output by all the worker modules used for training the model parameter of the second layer to obtain the second input data subblock of the third layer. t2 is a duration spent by the m worker modules on transmitting the first output subdata of the third layer to the fourth layer. t3 is a duration spent by the m worker modules on performing model parameter training on the first input data subblock of the third layer to obtain the first output subdata of the third layer. Alternatively, t3 is a duration spent by the m worker modules on performing model parameter training on the second input data subblock of the third layer to obtain the second output subdata of the third layer. Optionally, the duration spent by the m worker modules on performing model parameter training on the first input data subblock of the third layer to obtain the first output subdata of the third layer is the same as the duration spent by the m worker modules on performing model parameter training on the second input data subblock of the third layer to obtain the second output subdata of the third layer.

An embodiment of this application provides a possible application scenario, to apply the foregoing example. The foregoing example is applied to a scenario in which a deep neural network is used to classify an image data set. A source of the image data set is a computer vision system identification project (imagenet), including 1000 types of 1.28 million images in total. The neural network model uses VGG16, including 140 million model parameters in total, and 90% of the model parameters are concentrated on a fully connected layer. The distributed system architecture includes four nodes (node). Each node includes two worker modules and one server module. Each worker module corresponds to a K80 GPU card and a video RAM of 12 G. Each server module corresponds to an Intel Xeon E5-2620 CPU. VGG16 is currently a mainstream CNN network, and is widely used in image, video, and other analysis processes. Description is provided using a first round of iteration as an example.

The distributed system architecture is started, and applications are deployed. The model training mode of each layer in the neural network model is determined based on the foregoing solution. In VGG16, a first layer to a last pooling layer are determined as layers corresponding to the data parallel training mode. These layers form a first training layer (LayerSet). Considering a problem of communication bottleneck, each layer after the last pooling layer is determined as a layer corresponding to the model training mode. Each layer corresponding to the model training mode is a training layer. In the forward algorithm, input data of each layer corresponding to the model training mode is equally divided into a first input data subblock and a second input data subblock. In the backward algorithm, the input data of each layer corresponding to the model training mode is equally divided into a third input data subblock and a fourth input data subblock. To be specific, each layer after the last pooling (pooling) is longitudinally divided into two parts, and the two parts are allocated to two worker modules on one node for calculation or may be sequentially calculated on one worker module. This should be properly allocated based on a specific form of the distributed system architecture. In addition, a quantity m of worker modules used for training a model parameter of each layer corresponding to the model training mode is determined for the layer.

A training process is started, and a first iterative calculation is started. Input data (mini-batch) that is of each training layer and that is loaded on each node is divided into two parts, namely, a first input data subblock and a second input data subblock. For example, there are Q training layers in total. The forward algorithm is performed for q training layers, where q is equal to 1, 2, . . . , and Q. In a calculation process of each training layer, the first input data subblock is calculated first, and then the second input data subblock is calculated. After calculation of a current input data subblock of a current training layer is completed, transmission of output data of the input data subblock may be triggered, and calculation of a next input data subblock may be triggered.

After the forward algorithm is completed, the backward algorithm is started. The backward algorithm is sequentially performed for the q training layers, where q is equal to 1, 2, . . . , and Q. During calculation of a second input data subblock of a q^{th} training layer, first output subdata of the q^{th} training layer is transmitted. Similarly, during calculation of a first input data subblock of the q^{th} training layer, second output subdata of a (q−1)^{th} training layer is transmitted. In addition, when a training mode of a training layer is the data parallel training mode, a local gradient of a model parameter of the training layer is pushed to the server module after the local gradient is obtained, and a global gradient of the model parameter is pulled from the server module when the global gradient can be pulled from the server module. In this embodiment of this application, when global gradients of all the model parameters in the neural network model are obtained, it indicates that the current iteration is completed, and a next iteration is to be started.

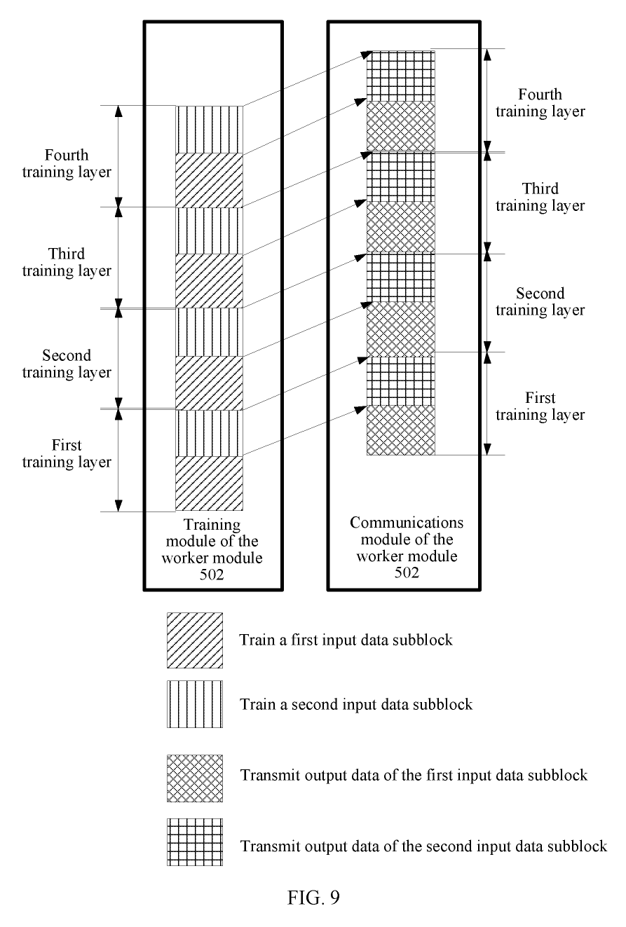

Based on a same concept, FIG. 10 shows an example of a training apparatus for a neural network model according to an embodiment of this application. The training apparatus is configured to perform the foregoing method procedure. The training apparatus provided in this embodiment of this application includes at least one worker module. The training apparatus is applicable to a training system that includes M worker modules. The neural network model includes L layers. M and L are integers greater than or equal to 1. For each of the L layers of the neural network model, the at least one worker module is used to train the layer. As shown in FIG. 10, a training apparatus 1000 includes at least one worker module, for example, a worker module 1001 shown in the figure. Each of the at least one worker module includes a management module 1002 and a training module 1003. Optionally, in this embodiment of this application, the worker module may further include a communications module 1004. The communications module is configured to implement data transmission between adjacent layers in the L layers of the neural network model, data transmission between worker modules, and data transmission between a worker module and a server module.

The management module is configured to determine, for each of the L layers of the neural network model, a model training mode of the layer based on an estimated data volume in a model parameter set and an estimated data volume of output data of the layer. The model training mode includes a data parallel training mode and a model parallel training mode. The model parameter set includes all model parameters of the layer.

The training module is configured to, when a forward algorithm of calculation from a first layer to an L^{th} layer is performed, and j is an integer greater than 1 and less than or equal to L, when the layer is the first layer in the neural network model, if the data parallel training mode is used for the first layer, use first input data as input data of the first layer, and perform data parallel training on a model parameter of the first layer, where the first input data is initial training data corresponding to the worker module; or if the model parallel training mode is used for the first layer, use second input data as input data of the first layer of the worker module, and perform model parallel training on a model parameter of the first layer, where the second input data is initial training data corresponding to the at least one worker module; or when the layer is a j^{th} layer in the neural network model, if the data parallel training mode is used for the j^{th} layer, use first output data as input data of the j^{th} layer, and perform data parallel training on a model parameter of the j^{th} layer, where the first output data is output data obtained by the worker module by training a (j−1)^{th} layer; or if the model parallel training mode is used for the j^{th} layer, use second output data as input data of the j^{th} layer, and perform model parallel training on a model parameter of the j^{th} layer, where the second output data is output data obtained by m worker modules by training a (j−1)^{th} layer, the m worker modules are one or more worker modules used for training the (j−1)^{th} layer, m is an integer greater than or equal to 1 and less than or equal to M, and a value of m of at least one of the L layers is greater than 1.

Optionally, the management module is configured to, when the estimated data volume in the model parameter set is not greater than the estimated data volume of the output data of the layer, determine that the model training mode of the layer is the data parallel training mode; or when the estimated data volume in the model parameter set is greater than the estimated data volume of the output data of the layer, determine that the model training mode of the layer is the model parallel training mode.

Optionally, if the model parallel training mode is used for the j^{th} layer, the training module is configured to, determine, based on a model parameter set of the j^{th} layer, a model parameter subset that is of the j^{th} layer and that is to be trained by the worker module; and use the second output data as the input data of the j^{th} layer, and perform the model parallel training on the model parameter subset of the j^{th} layer. An intersection set between model parameter subsets of the j^{th} layer that are trained by any two of the at least one worker module is empty. A union set of model parameter subsets of the j^{th} layer that are trained by all of the at least one worker module is equal to a universal set of model parameters of the j^{th} layer.

Optionally, if the model parallel training mode is used for the j^{th} layer, the management module is further configured to perform Step A includes setting a value of i to an integer greater than or equal to 1 and less than or equal to M, estimating a first total duration spent by i worker modules on training, and performing step B, where the first total duration is an estimated total duration spent by all of the i worker modules on receiving the second input data and training the model parameter of the j^{th} layer based on the second input data; step B includes updating the value of i, where the updated value of i is another integer greater than or equal to 1 and less than or equal to M, and performing step C; step C includes estimating a second total duration spent by updated i worker modules on training, where the second total duration is an estimated total duration spent by all of the updated i worker modules on receiving the second input data and training the model parameter of the j^{th} layer based on the second input data, where each value of i corresponds to one total duration; and if a sum of a quantity of first total durations and a quantity of second total durations is less than a quantity threshold, performing step B; or if a sum of a quantity of first total durations and a quantity of second total durations is equal to a quantity threshold, performing step D; and step D includes determining a total duration with a smaller value in the first total duration and the second total duration, and using a value that is of i and that corresponds to the total duration with a smaller value as a determined value of a quantity of the at least one worker module used for training the j^{th} layer.

Optionally, if the model parallel training mode is used for the j^{th} layer, the second output data is divided into a first input data subblock and a second input data subblock, and the training module is configured to receive the first input data subblock; perform in parallel the following steps. For instance, performing the model parallel training on the model parameter of the j^{th} layer based on the first input data subblock, to obtain first output subdata of the j^{th} layer, and receiving the second input data subblock; and perform in parallel the following steps. For instance, performing the model parallel training on the model parameter of the j^{th} layer based on the second input data subblock, to obtain second output subdata of the j^{th} layer, and transmitting the first output subdata of the j^{th} layer to a (j+1)^{th} layer.

Optionally, the management module is further configured to estimate, in the following manner, a total duration t spent by the m worker modules on separately receiving the second input data and training the model parameter of the j^{th} layer based on the second input data includes t=max{t1, t3}+max{t2, t3}, where t1 is a duration spent by the m worker modules on receiving the second input data subblock; t2 is a duration spent by the m worker modules on transmitting the first output subdata of the j^{th} layer to the (j+1)^{th} layer; and t3 is a duration spent by the m worker modules on performing the model parallel training on the model parameter of the j^{th} layer based on the first input data subblock to obtain the first output subdata of the j^{th} layer; or t3 is a duration spent by the m worker modules on performing the model parallel training on the model parameter of the j^{th} layer based on the second input data subblock to obtain the second output subdata of the j^{th} layer.

Optionally, the training module is further configured to, if a backward algorithm of calculation from the L^{th} layer to the first layer is performed, and j is an integer greater than or equal to 1 and less than L, when the layer is the L^{th} layer in the neural network model, if the data parallel training mode is used for the L^{th} layer, use third input data as input data of the L^{th} layer, and perform data parallel training on a model parameter of the L^{th} layer, where the third input data is output data that is of the L^{th} layer in the forward algorithm and that corresponds to the worker module; or if the model parallel training mode is used for the L^{th} layer, use fourth input data as input data of the L^{th} layer of the worker module, and perform model parallel training on a model parameter of the L^{th} layer, where the fourth input data is output data obtained by the at least one worker module by training the model parameter of the L^{th} layer in the forward algorithm; or when the layer is a j^{th} layer in the neural network model, if the data parallel training mode is used for the j^{th} layer, use third output data as input data of the j^{th} layer, and perform data parallel training on a model parameter of the j^{th} layer, where the third output data is output data obtained by the worker module by training a (j+1)^{th} layer; or if the model parallel training mode is used for the j^{th} layer, use fourth output data as input data of the j^{th} layer, and perform model parallel training on a model parameter of the j^{th} layer, where the fourth output data is output data obtained by m worker modules by training a (j+1)^{th} layer, the m worker modules are one or more worker modules used for training the (j+1)^{th} layer, m is an integer greater than or equal to 1 and less than or equal to M, and a value of m of at least one of the L layers is greater than 1.

Optionally, if a backward algorithm of calculation from the L^{th} layer to the first layer is performed, j is an integer greater than or equal to 1 and less than L, and the model parallel training mode is used for the j^{th} layer, the training module is configured to, determine, based on a model parameter set of the j^{th} layer, a model parameter subset that is of the j^{th} layer and that is to be trained by the worker module; and use the fourth output data as the input data of the j^{th} layer, and perform the model parallel training on the model parameter subset of the j^{th} layer. An intersection set between model parameter subsets of the j^{th} layer that are trained by any two of the at least one worker module is empty. A union set of model parameter subsets of the j^{th} layer that are trained by all of the at least one worker module is equal to a universal set of model parameters of the j^{th} layer.

Optionally, if a backward algorithm of calculation from the L^{th} layer to the first layer is performed, j is an integer greater than or equal to 1 and less than L, and the model parallel training mode is used for the j^{th} layer, the fourth output data is divided into a third input data subblock and a fourth input data subblock.

The training module is configured to receive the third input data subblock; perform in parallel the following steps. For instance, performing the model parallel training on the model parameter of the j^{th} layer based on the third input data subblock, to obtain third output subdata of the j^{th} layer, and receiving the fourth input data subblock; and perform in parallel the following steps. For instance, performing the model parallel training on the model parameter of the j^{th} layer based on the fourth input data subblock, to obtain the fourth output subdata of the j^{th} layer, and transmitting the third output subdata of the j^{th} layer to a (j−1)^{th} layer.

It can be learned from the foregoing content that, in this embodiment of this application, the model training mode of each layer is determined based on the estimated data volume in the model parameter set and the estimated data volume of the output data of the layer. In this way, if the model parallel training mode is used for the j^{th} layer, the worker module uses the second output data as the input data of the j^{th} layer, and performs the model parallel training on the model parameter of the j^{th} layer. The second output data is the output data obtained by the m worker modules by training the (j−1)^{th} layer. To be specific, for the j^{th} layer corresponding to the model parallel training mode, the worker module receives the output data of the m worker modules. The data may be referred to as full data. The worker module may directly obtain a global gradient of the model parameter by training the model parameter based on the full data. Compared with the prior art solution in which a worker module pushes a local gradient of a model parameter to a server module and pulls a global gradient of the model parameter from the server module to obtain the global gradient of the model parameter, this embodiment of this application reduces the communication volume between the worker module and the server module.

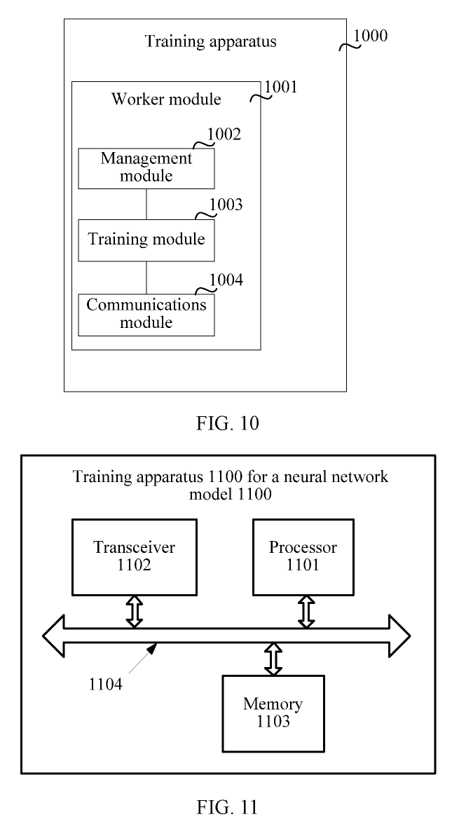

Based on a same concept, FIG. 11 shows an example of a training apparatus for a neural network model according to an embodiment of this application. The training apparatus is configured to perform the foregoing method procedure. The training apparatus 1100 provided in this embodiment of this application includes a processor 1101, a transceiver 1102, and a memory 1103. The processor 1101 includes at least one processor core. The training apparatus is applicable to a training system that includes M processor cores. The neural network model includes L layers. M and L are integers greater than or equal to 1. For each of the L layers of the neural network model, the at least one processor core is used to train the layer.

The processor, the memory, and the transceiver are connected to one another using a bus. The bus may be a peripheral component interconnect (PCI) bus, an extended industry standard architecture (EISA) bus, or the like. The bus may be categorized as an address bus, a data bus, a control bus, or the like. For ease of indication, the bus is indicated using only one bold line in FIG. 11. However, it does not indicate that there is only one bus or only one type of bus.

The memory may include a volatile memory, for example, a random-access memory (RAM). The memory may alternatively include a non-volatile memory, for example, a flash memory, a hard disk drive (HDD), or a solid-state drive (SSD). The memory may alternatively include a combination of the foregoing types of memories.

The at least one processor core included in the processor may include a GPU, or may include a GPU and a CPU. The processor core may further include a hardware chip. The hardware chip may be an application-specific integrated circuit (ASIC), a programmable logic device (PLD), or a combination thereof. The foregoing PLD may be a complex programmable logic device (CPLD), a field-programmable gate array (FPGA), a generic array logic (GAL), or any combination thereof.

The transceiver is configured to implement data transmission between adjacent layers in the L layers of the neural network model, data transmission between worker modules, and data transmission between a worker module and a server module.

The memory is configured to store an instruction. Optionally, the memory is further configured to store information such as a determined model training mode of each layer.

The processor is configured to execute the instruction stored in the memory, and control data transmission between the transceiver and another processor core of the M processor cores. Optionally, the M processor cores may transmit data to each other through inter-core communication, for example, transmit data using the bus between the processor cores. Optionally, the processor further controls data transmission between the transceiver and the server module.

When the processor executes the instruction stored in the memory, each of the at least one processor core is configured to determine, for each of the L layers of the neural network model, a model training mode of the layer based on an estimated data volume in a model parameter set and an estimated data volume of output data of the layer, where the model training mode includes a data parallel training mode and a model parallel training mode, and the model parameter set includes all model parameters of the layer; and perform the following operations to train the layer, when a forward algorithm of calculation from a first layer to an L^{th} layer is performed, and j is an integer greater than 1 and less than or equal to L, when the layer is the first layer in the neural network model, if the data parallel training mode is used for the first layer, using first input data as input data of the first layer, and performing data parallel training on a model parameter of the first layer, where the first input data is initial training data corresponding to the worker module; or if the model parallel training mode is used for the first layer, using second input data as input data of the first layer of the worker module, and performing model parallel training on a model parameter of the first layer, where the second input data is initial training data corresponding to the at least one worker module; or when the layer is a j^{th} layer in the neural network model, if the data parallel training mode is used for the j^{th} layer, using first output data as input data of the j^{th} layer, and performing data parallel training on a model parameter of the j^{th} layer, where the first output data is output data obtained by the worker module by training a (j−1)^{th} layer; or if the model parallel training mode is used for the j^{th} layer, using second output data as input data of the j^{th} layer, and performing model parallel training on a model parameter of the j^{th} layer, where the second output data is output data obtained by m worker modules by training a (j−1)^{th} layer, the m worker modules are one or more worker modules used for training the (j−1)^{th} layer, m is an integer greater than or equal to 1 and less than or equal to M, and a value of m of at least one of the L layers is greater than 1.

Optionally, the processor is configured to when the estimated data volume in the model parameter set is not greater than the estimated data volume of the output data of the layer, determine that the model training mode of the layer is the data parallel training mode; or when the estimated data volume in the model parameter set is greater than the estimated data volume of the output data of the layer, determine that the model training mode of the layer is the model parallel training mode.

Optionally, if the model parallel training mode is used for the j^{th} layer, the processor is configured to determine, based on a model parameter set of the j^{th} layer, a model parameter subset that is of the j^{th} layer and that is to be trained by the worker module; and use the second output data as the input data of the j^{th} layer, and perform the model parallel training on the model parameter subset of the j^{th} layer. An intersection set between model parameter subsets of the j^{th} layer that are trained by any two of the at least one worker module is empty. A union set of model parameter subsets of the j^{th} layer that are trained by all of the at least one worker module is equal to a universal set of model parameters of the j^{th} layer.

Optionally, if the model parallel training mode is used for the j^{th} layer, the processor is further configured to perform steps. Step A includes setting a value of i to an integer greater than or equal to 1 and less than or equal to M, estimating a first total duration spent by i worker modules on training, and performing step B, where the first total duration is an estimated total duration spent by all of the i worker modules on receiving the second input data and training the model parameter of the j^{th} layer based on the second input data; step B includes updating the value of i, where the updated value of i is another integer greater than or equal to 1 and less than or equal to M, and performing step C; step C includes estimating a second total duration spent by updated i worker modules on training, where the second total duration is an estimated total duration spent by all of the updated i worker modules on receiving the second input data and training the model parameter of the j^{th} layer based on the second input data, where each value of i corresponds to one total duration; and if a sum of a quantity of first total durations and a quantity of second total durations is less than a quantity threshold, performing step B; or if a sum of a quantity of first total durations and a quantity of second total durations is equal to a quantity threshold, performing step D; and step D includes determining a total duration with a smaller value in the first total duration and the second total duration, and using a value that is of i and that corresponds to the total duration with a smaller value as a determined value of a quantity of the at least one worker module used for training the j^{th} layer.

Optionally, if the model parallel training mode is used for the j^{th} layer, the second output data is divided into a first input data subblock and a second input data subblock, and the processor is configured to receive the first input data subblock; perform in parallel the following steps. For instance, performing the model parallel training on the model parameter of the j^{th} layer based on the first input data subblock, to obtain first output subdata of the j^{th} layer, and receiving the second input data subblock; and perform in parallel the following steps. For instance, performing the model parallel training on the model parameter of the j^{th} layer based on the second input data subblock, to obtain second output subdata of the j^{th} layer, and transmitting the first output subdata of the j^{th} layer to a (j+1)^{th} layer.

Optionally, the processor is further configured to estimate, in the following manner, a total duration t spent by the m worker modules on separately receiving the second input data and training the model parameter of the j^{th} layer based on the second input data.

t=max{t1, t3}+max{t2, t3}, where

t1 is a duration spent by the m worker modules on receiving the second input data subblock; t2 is a duration spent by the m worker modules on transmitting the first output subdata of the j^{th} layer to the (j+1)^{th} layer; and t3 is a duration spent by the m worker modules on performing the model parallel training on the model parameter of the j^{th} layer based on the first input data subblock to obtain the first output subdata of the j^{th} layer; or t3 is a duration spent by the m worker modules on performing the model parallel training on the model parameter of the j^{th} layer based on the second input data subblock to obtain the second output subdata of the j^{th} layer.

Optionally, the processor is further configured to, if a backward algorithm of calculation from the L^{th} layer to the first layer is performed, and j is an integer greater than or equal to 1 and less than L, when the layer is the L^{th} layer in the neural network model, if the data parallel training mode is used for the L^{th} layer, use third input data as input data of the L^{th} layer, and perform data parallel training on a model parameter of the L^{th} layer, where the third input data is output data that is of the L^{th} layer in the forward algorithm and that corresponds to the worker module; or if the model parallel training mode is used for the L^{th} layer, use fourth input data as input data of the L^{th} layer of the worker module, and perform model parallel training on a model parameter of the L^{th} layer, where the fourth input data is output data obtained by the at least one worker module by training the model parameter of the L^{th} layer in the forward algorithm; or when the layer is a j^{th} layer in the neural network model, if the data parallel training mode is used for the j^{th} layer, use third output data as input data of the j^{th} layer, and perform data parallel training on a model parameter of the j^{th} layer, where the third output data is output data obtained by the worker module by training a (j+1)^{th} layer; or if the model parallel training mode is used for the j^{th} layer, use fourth output data as input data of the j^{th} layer, and perform model parallel training on a model parameter of the j^{th} layer, where the fourth output data is output data obtained by m worker modules by training a (j+1)^{th} layer, the m worker modules are one or more worker modules used for training the (j+1)^{th} layer, m is an integer greater than or equal to 1 and less than or equal to M, and a value of m of at least one of the L layers is greater than 1.

Optionally, if a backward algorithm of calculation from the L^{th} layer to the first layer is performed, j is an integer greater than or equal to 1 and less than L, and the model parallel training mode is used for the j^{th} layer the processor is configured to determine, based on a model parameter set of the j^{th} layer, a model parameter subset that is of the j^{th} layer and that is to be trained by the worker module; and use the fourth output data as the input data of the j^{th} layer, and perform the model parallel training on the model parameter subset of the j^{th} layer. An intersection set between model parameter subsets of the j^{th} layer that are trained by any two of the at least one worker module is empty. A union set of model parameter subsets of the j^{th} layer that are trained by all of the at least one worker module is equal to a universal set of model parameters of the j^{th} layer.

Optionally, if a backward algorithm of calculation from the L^{th} layer to the first layer is performed, j is an integer greater than or equal to 1 and less than L, and the model parallel training mode is used for the j^{th} layer, the fourth output data is divided into a third input data subblock and a fourth input data subblock.

The processor is configured to receive the third input data subblock; perform in parallel the following steps. For instance, performing the model parallel training on the model parameter of the j^{th} layer based on the third input data subblock, to obtain third output subdata of the j^{th} layer, and receiving the fourth input data subblock; and perform in parallel the following steps. For instance, performing the model parallel training on the model parameter of the j^{th} layer based on the fourth input data subblock, to obtain the fourth output subdata of the j^{th} layer, and transmitting the third output subdata of the j^{th} layer to a (j−1)^{th} layer.

It can be learned from the foregoing content that, in this embodiment of this application, the model training mode of each layer is determined based on the estimated data volume in the model parameter set and the estimated data volume of the output data of the layer. In this way, if the model parallel training mode is used for the j^{th} layer, the worker module uses the second output data as the input data of the j^{th} layer, and performs the model parallel training on the model parameter of the j^{th} layer. The second output data is the output data obtained by the m worker modules by training the (j−1)^{th} layer. To be specific, for the j^{th} layer corresponding to the model parallel training mode, the worker module receives the output data of the m worker modules. The data may be referred to as full data. The worker module may directly obtain a global gradient of the model parameter by training the model parameter based on the full data. Compared with the prior art solution in which a worker module pushes a local gradient of a model parameter to a server module and pulls a global gradient of the model parameter from the server module to obtain the global gradient of the model parameter, this embodiment of this application reduces the communication volume between the worker module and the server module.

Based on a same concept, an embodiment of this application provides a training chip for a neural network model. The chip is applicable to a training system that includes M chips. The neural network model includes L layers. M and L are integers greater than or equal to 1. For each of the L layers of the neural network model, at least one of the M chips is used to train the layer. Each of the at least one chip is configured to perform the method performed by the worker module or the processor core in the foregoing content.

All or some of the foregoing embodiments may be implemented using software, hardware, firmware, or any combination thereof. When software is used to implement the embodiments, the embodiments may be implemented completely or partially in a form of a computer program product. The computer program product includes one or more computer instructions. When the computer program instructions are loaded and executed on a computer, the procedures or functions according to the embodiments of the present disclosure are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid state disk solid state disk (SSD)), or the like.

Persons skilled in the art should understand that the embodiments of this application may be provided as a method or a computer program product. Therefore, this application may use a form of hardware only embodiments, software only embodiments, or embodiments with a combination of software and hardware. Moreover, this application may use a form of a computer program product that is implemented on one or more computer-usable storage media (including but not limited to a disk memory, a CD-ROM, an optical memory, and the like) that include computer usable program code.

This application is described with reference to the flowcharts and/or block diagrams of the method, the device (system), and the computer program product according to the embodiments of this application. It should be understood that computer program instructions may be used to implement each process and/or each block in the flowcharts and/or the block diagrams, and a combination of a process and/or a block in the flowcharts and/or the block diagrams. These computer program instructions may be provided for a general-purpose computer, a dedicated computer, an embedded processor, or a processor of any other programmable data processing device to generate a machine, such that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, such that the instructions stored in the computer readable memory generate an artifact that includes an instruction apparatus. The instruction apparatus implements a specified function in one or more processes in the flowcharts and/or in one or more blocks in the block diagrams.

These computer program instructions may also be loaded onto a computer or another programmable data processing device, such that a series of operations and steps are performed on the computer or the other programmable device, thereby generating computer-implemented processing. Therefore, the instructions executed on the computer or the other programmable device provide steps for implementing a specific function in one or more processes in the flowcharts and/or in one or more blocks in the block diagrams.

Although some embodiments of this application have been described, persons skilled in the art can make changes and modifications to these embodiments once they learn the basic inventive concept. Therefore, the following claims are intended to be construed as to cover the embodiments and all changes and modifications falling within the scope of this application.

Obviously, persons skilled in the art can make various modifications and variations to this application without departing from the scope of this application. This application is intended to cover these modifications and variations of this application provided that they fall within the scope of protection defined by the following claims and their equivalent technologies.

What is claimed is:

1. A training method for a neural network model applied to a training system, wherein the training method comprises:
determining, by each of at least one M processor cores for each layer of L layers of the neural network model, a model training mode of a layer of the L layers based on an estimated data volume in a model parameter set and an estimated data volume of output data of the layer, wherein the training system comprises the M processor cores, and wherein M and L are integers greater than or equal to 1; and
performing, by each of the M processor cores, training to the layer using a determined model training mode, wherein the determined model training mode comprises at least one of a data parallel training mode or a model parallel training mode.

2. The training method of claim 1, wherein the determined model training mode of a (j−1)^{th} layer of the L layers is the data parallel training mode, wherein j is an integer greater than 1 and less than or equal to L, wherein the performing comprises performing data parallel training on a model parameter of the (j−1)^{th} layer, wherein first output data is used as input data of a j^{th} layer of the L layers, and wherein the first output data is output data obtained by each of the M processor cores training the (j−1)^{th} layer.

3. The training method of claim 1, wherein the determined model training mode of a (j−1)^{th} layer of the L layers is the model parallel training mode, wherein j is an integer greater than 1 and less than or equal to L, wherein the performing comprises performing model parallel training on a model parameter of the (j−1)^{th} layer, wherein second output data is used as input data of a j^{th} layer of the L layers, wherein the second output data is output data obtained by m processor cores training the (j−1)^{th} layer, wherein the m processor cores are one or more of the M processor cores used for training the (j−1)^{th} layer, wherein m is an integer greater than or equal to 1 and less than or equal to M, and wherein a value of m of at least one of the L layers is greater than 1.

4. The training method of claim 1, wherein when the estimated data volume in the model parameter set is not greater than the estimated data volume of the output data of a layer, the model training mode of the layer is the data parallel training mode.

5. The training method of claim 1, wherein when the estimated data volume in the model parameter set is greater than the estimated data volume of the output data of a layer, the model training mode of the layer is the model parallel training mode.

6. The training method of claim 1, wherein the determined model training mode of a (j−1)^{th} layer of the L layers is the model parallel training mode, wherein j is an integer greater than 1 and less than or equal to L, wherein the performing comprises:
determining, based on a model parameter set of a j^{th} layer of the L layers, a model parameter subset of the j^{th} layer that is to be trained by each of the M processor cores; and
performing the model parallel training on the model parameter subset of the j^{th} layer, wherein second output data is used as input data of the j^{th} layer and an intersection set between model parameter subsets of the j^{th} layer that are trained by any two of the at least one M processors is empty, wherein the second output data is output data obtained by m processor cores training a (j−1)^{th} layer of the L layers, and wherein a union set of model parameter subsets of the j^{th} layer that are trained by all of the at least one M processor core is equal to a universal set of model parameters of the j^{th} layer.

7. The training method of claim 1, wherein based on the model parallel training mode being used for a j^{th} layer, the method further comprises:
dividing second output data into a first input data subblock and a second input data subblock, wherein the second output data is output data obtained by m processor cores training a (j−1)^{th} layer of the L layers;
using the second output data as input data of the j^{th} layer of the L layers;
performing model parallel training on a model parameter of the j^{th} layer of the L layers, comprising:
receiving the first input data subblock;
performing in parallel all of the following:
performing the model parallel training on the model parameter of the j^{th} layer based on the first input data subblock to obtain first output subdata of the j^{th} layer;
receiving the second input data subblock; and
performing the model parallel training on the model parameter of the j^{th} layer based on the second input data subblock to obtain second output subdata of the j^{th} layer; and
transmitting the first output subdata of the j^{th} layer to a (j+1)^{th} layer of the L layers.

8. A training apparatus for a neural network model, wherein the training apparatus comprises:
a memory configured to store instructions;
a processor coupled to the memory and configured to execute the instructions, wherein the processor comprises at least one processor core; and
a transceiver coupled to the processor and the memory, wherein the training apparatus is applicable to a training system that comprises M processor cores, wherein the neural network model comprises L layers, wherein M and L are integers greater than or equal to 1, wherein for each layer of the L layers, the at least one processor core is used to train the layer, wherein the processor is configured to control the transceiver to transmit data to a second processor core in the M processor cores, and wherein the instructions cause each of the at least one processor core to be configured to:
determining, a model training mode of the layer based on an estimated data volume in a model parameter set and an estimated data volume of output data of the layer, wherein the training system comprises at least one M processor cores; and
performing, an training to the layer using a determined training mode, wherein the determined model training mode comprises at least one of a data parallel training mode or a model parallel training mode.

9. The training apparatus of claim 8, wherein the determined model training mode of a (j−1)^{th} layer of the L layers is the data parallel training mode, wherein j is an integer greater than 1 and less than or equal to L, wherein the instructions further cause each of the at least one processor core to perform data parallel training on a model parameter of a j^{th} layer of the L layers, wherein first output data is used as input data of the j^{th} layer, and wherein the first output data is output data obtained by each of the at least one processor core by training a (j−1)^{th} layer.

10. The training apparatus of claim 8, wherein the determined model training mode of a (j−1)^{th} layer of the L layers is the model parallel training mode, wherein j is an integer greater than 1 and less than or equal to L, wherein the instructions further cause each of the at least one processor core to perform model parallel training on a model parameter of a j^{th} layer of the L layers, wherein a second output data is used as input data of the j^{th} layer, wherein the second output data is output data obtained by m processor cores training the (j−1)^{th} layer, wherein the m processor cores are one or more of the M processor cores used for training the (j−1)^{th} layer, wherein m is an integer greater than or equal to 1 and less than or equal to M, and wherein a value of m of at least one of the L layers is greater than 1.

11. The training apparatus of claim 8, wherein when the estimated data volume in the model parameter set is not greater than the estimated data volume of the output data of a layer, the model training mode of the layer is the data parallel training mode.

12. The training apparatus of claim 8, wherein when the estimated data volume in the model parameter set is greater than the estimated data volume of the output data of a layer, the model training mode of the layer is the model parallel training mode.

13. The training apparatus of claim 8, wherein when the model parallel training mode is used for a j^{th} layer of the L layers, the instructions to cause each of the at least one processor core to use second output data as input data of the j^{th} layer and to perform model parallel training on a model parameter of the j^{th} layer further comprises instructions to cause each of the at least one processor core to:
determine, based on a model parameter set of the j^{th} layer, a model parameter subset of the j^{th} layer that is to be trained by each of the processor cores;
perform the model parallel training on the model parameter subset of the j^{th} layer, wherein the second output data is used as the input data of the j^{th} layer and an intersection set between model parameter subsets of the j^{th} layer that are trained by any two of the at least one M processors is empty, and wherein a union set of model parameter subsets of the j^{th} layer that are trained by all of the at least one M processor core is equal to a universal set of model parameters of the j^{th} layer.

14. The training apparatus of claim 8, wherein when the model parallel training mode is used for a j^{th} layer of the L layers and before the performing, the instructions further cause each of the at least one processor core to:
set a value of i to an integer that is greater than or equal to 1 and less than or equal to M;
estimate a first total duration of i processor cores on training, wherein the first total duration is an estimated total duration of all the i processor cores on receiving a second input data and training the model parameter of the j^{th} layer based on the second input data;
update the value of i, wherein the updated value of i is another integer greater than or equal to 1 and less than or equal to M;
estimate a second total duration of updated i processor cores on training, wherein the second total duration is an estimated total duration of the updated i processor cores on receiving the second input data and training the model parameter of the j^{th} layer based on the second input data, wherein each value of i corresponds to one total duration;
either update the value of i when a sum of a quantity of first total durations and a quantity of second total durations is less than a quantity threshold; or
determine a third total duration based on a sum of a quantity of first total durations and a quantity of second total durations is equal to a quantity threshold, wherein the total duration comprises a smaller value in the first total duration and the second total duration; and
use a second value of i that corresponds to the total duration with a smaller value as a determined value of a quantity of the at least one processor core used for training the j^{th} layer.

15. A training chip for a neural network model, applicable to a training system that comprises M chips, wherein the neural network model comprises L layers, wherein each of the M chips comprises at least one processor core, and wherein each of the at least one chip is configured to:
determine, by each of at least one M processor cores for each layer of L layers of the neural network model, a model training mode of a layer of the L layers based on an estimated data volume in a model parameter set and an estimated data volume of output data of the layer, wherein the training system comprises at least one M processor cores, and wherein M and L are integers greater than or equal to 1; and
perform, by each of the M processor cores, an training to the layer using a determined training mode, wherein the determined model training mode comprises at least one of a data parallel training mode or a model parallel training mode.

16. The training chip of claim 15, wherein the determined model training mode of a (j−1)^{th} layer of the L layers is the data parallel training mode, wherein j is an integer greater than 1 and less than or equal to L, wherein each of the at least chip is configured to perform data parallel training on a model parameter of a j^{th} layer of the L layers, wherein first output data is used as input data of the j^{th} layer, and wherein the first output data is output data obtained by each of the at least one chip training the (j−1)^{th} layer.

17. The training chip of claim 15, wherein the determined model training mode of a (j−1)^{th} layer of the L layers is model parallel training mode, wherein j is an integer greater than 1 and less than or equal to L, wherein each of the at least one chip is configured to perform model parallel training on a model parameter of a j^{th} layer of the L layers, wherein second output data is used as input data of the j^{th} layer, wherein the second output data is output data obtained by m processor cores training the (j−1)^{th} layer, wherein the m processor cores are one or more of the M processor cores used for training the (j−1)^{th} layer, wherein m is an integer greater than or equal to 1 and less than or equal to M, and wherein a value of m of at least one of the L layers is greater than 1.

18. The training chip of claim 16, wherein when the estimated data volume in the model parameter set is not greater than the estimated data volume of the output data of a layer, the model training mode of the layer is the data parallel training mode.

19. The training chip of claim 16, wherein when the estimated data volume in the model parameter set is greater than the estimated data volume of the output data of a layer, the model training mode of the layer is the model parallel training mode.

20. The training chip of claim 16, wherein when the model parallel training mode is used for the j^{th} layer, each of the at least one chip is configured to use second output data as input data of the j^{th} layer, wherein each of the at least one chip is configured to:
determine, based on a model parameter set of the j^{th} layer, a model parameter subset of the j^{th} layer that is to be trained by each of the M processor cores; and
perform the model parallel training on the model parameter subset of the j^{th} layer, wherein the second output data is used as the input data of the j^{th} layer and an intersection set between model parameter subsets of the j^{th} layer that are trained by any two of the at least one M processors is empty, and wherein a union set of model parameter subsets of the j^{th} layer that are trained by all of the at least one M processor core is equal to a universal set of model parameters of the j^{th} layer.
